(19) United States
(12) Patent Application Publication
(10) Pub. No.: US 2025/0316765 A1
(43) Pub. Date: Oct. 9, 2025

(54) LOWER FLAMMABILITY ELECTROLYTE COMPOSITIONS

(71) Applicant: ENEVATE CORPORATION, Irvine, CA (US)

(72) Inventors: Daniel Sylvinson Muthiah Ravinson, Irvine, CA (US); Heidi Anderson, Irvine, CA (US); Chang Wook Kim, Irvine, CA (US); Benjamin Yong Park, Irvine, CA (US)

(21) Appl. No.: 18/990,610

(22) Filed: Dec. 20, 2024

Related U.S. Application Data
(60) Provisional application No. 63/575,115, filed on Apr. 5, 2024.
(60) Provisional application No. 63/575,185, filed on Apr. 5, 2024.
(60) Provisional application No. 63/575,200, filed on Apr. 5, 2024.

(51) Int. Cl. H01M 10/0569; H01M 4/38; H01M 10/0567; H01M 10/0568

(52) U.S. Cl. CPC H01M 10/0569; H01M 4/386; H01M 10/0567; H01M 10/0568; H01M 2300/004; H01M 2300/0051

(57) ABSTRACT

Electrolyte compositions comprising electrolyte additives and/or solvents for reduction of thermal propagation in lithium-ion batteries are disclosed. Energy storage devices comprising the electrolyte compositions comprise a first electrode and a second electrode, wherein at least one of the first electrode and the second electrode may be a Si-based electrode, a separator between the first electrode and the second electrode, and the electrolyte composition.

### CROSS-REFERENCE TO RELATED APPLICATIONS/INCORPORATION BY REFERENCE

This application claims the benefit of and priority to U.S. Provisional Patent Application No. 63/575,115, titled “CELLS WITH INSULATION PAPER WRAPPING FOR DELAYED HEAT PROPAGATION,” filed Apr. 5, 2024. This application also claims the benefit of and priority to U.S. Provisional Patent Application No. 63/575,185, titled “HIGH HEAT CAPACITY MATERIALS FOR IMPROVED SAFETY OF HIGH ENERGY DENSITY BATTERIES,” filed Apr. 5, 2024. This application also claims the benefit of and priority to U.S. Provisional Patent Application No. 63/575,200, titled “SAFETY-ENHANCEMENT STATE-OF-CHARGE (SOC) REDUCTION DEVICES FOR PROPAGATION RESISTANT LITHIUM-ION BATTERIES,” filed Apr. 5, 2024.

Each of these disclosures are incorporated herein by reference in their entirety.

### FIELD

Aspects of the present disclosure relate to energy generation and storage. More specifically, certain embodiments of the disclosure relate to electrolyte compositions for reduction of thermal propagation.

### BACKGROUND

Conventional approaches for battery electrolyte compositions may be costly, cumbersome, and/or inefficient—e.g., they may be complex and/or time-consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method for using electrolyte compositions for reduction of thermal propagation, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1A is a diagram of example batteries, in accordance with an example embodiment of the disclosure.

FIG. 1B is a diagram of an example battery management system (BMS), in accordance with an example embodiment of the disclosure.

FIG. 2A is a flow diagram of a lamination process for forming a silicon-dominant anode cell, in accordance with an example embodiment of the disclosure.

FIG. 2B is a flow diagram of a direct coating process for forming a silicon-dominant anode cell, in accordance with an example embodiment of the disclosure.

FIGS. 3A-3B shows the results of cells with different electrolytes, where FIG. 3A shows cycle performance and FIG. 3B shows 10s-DCIR, in accordance with an example embodiment of the disclosure.

FIGS. 4A-4B shows the results of the thermal propagation test for cells containing the flammable control electrolyte (EL) (FIG. 4A) and the flame-retardant EL (EL-4) (FIG. 4B), in accordance with an example embodiment of the disclosure.

FIG. 5 shows TR pressure evolution of 2.2 Ah NCM811|Si cells containing El-a and EL-b compared with 2.2 Ah NCM811|Graphite cells with EL-a, in accordance with an example embodiment of the disclosure.

FIGS. 6A-6B show TR Pressure evolution of cell design with different electrolytes where both are Si-dominant cells and have identical cell components except for the anode design. FIG.6A shows Design A and FIG. 6B shows Design B, in accordance with example embodiments of the disclosure.

### DETAILED DESCRIPTION

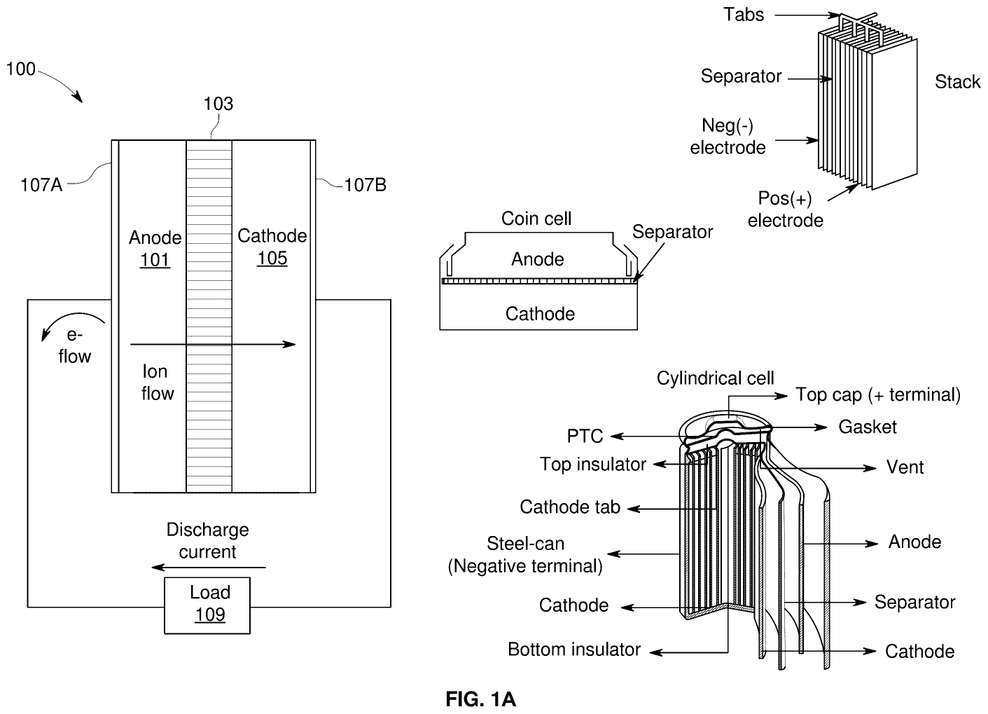

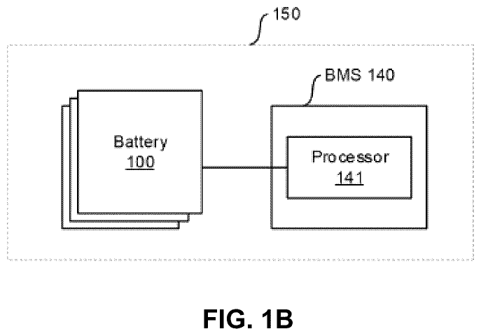

FIG. 1A is a diagram of a battery with silicon-dominant anodes, in accordance with an example embodiment of the disclosure. Referring to FIG. 1A, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack. Furthermore, the battery 100 shown in FIG. 1A is a very simplified example merely to show the principle of operation of a lithium-ion cell. Examples of realistic structures are shown to the right in FIG. 1A, where stacks of electrodes and separators are utilized, with electrode coatings typically on both sides of the current collectors. The stacks may be formed into different shapes, such as a coin cell, cylindrical cell, or prismatic cell, for example.

The development of portable electronic devices and electrification of transportation drive the need for high-performance electrochemical energy storage. Small-scale (<100 Wh) to large-scale (>10 KWh) devices primarily use lithium-ion (Li-ion) batteries over other rechargeable battery chemistries due to their high performance.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode are electrically coupled to the current collectors 107A and 107B, which comprise metal or other conductive material for providing electrical contact to the electrodes as well as physical support for the active material in forming electrodes.

The configuration shown in FIG. 1A illustrates the battery 100 in discharge mode, whereas in a charging configuration, load 109 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. Sheets of the cathode, separator, and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄ etc. In an example scenario, the electrolyte may comprise Lithium hexafluorophosphate (LiPF₆) and lithium bis(trifluoromethanesulfonyl)imide (LiTFSI) that may be used together in a variety of electrolyte solvents. Lithium hexafluorophosphate (LiPF₆) may be present at a concentration of about 0.1 to 4.0 molar (M) and lithium bis(trifluoromethanesulfonyl)imide (LiTFSI) may be present at a concentration of about 0 to 4.0 molar (M). Solvents may comprise one or more of ethylene carbonate (EC), fluoroethylene carbonate (FEC), and/or ethyl methyl carbonate (EMC) in various percentages. In some embodiments, the electrolyte solvents may comprise one or more of EC from about 0-40%, FEC from about 2-40%, and/or EMC from about 50-70%

The separator 103 may be wet or soaked with a liquid or gel electrolyte. In addition, in an example embodiment, the separator 103 does not melt below about 100 to 120° C. and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through gelling or other processes even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for the transfer of electrical charge in charge and discharge states. The anode 101 may comprise silicon, carbon, or combinations of these materials, for example. Typical anode electrodes comprise a carbon material that includes a current collector such as a copper sheet. Carbon is often used because it has excellent electrochemical properties and is also electrically conductive. Anode electrodes currently used in rechargeable lithium-ion cells typically have a specific capacity of approximately 200 milliampere hours per gram. Graphite, the active material used in most lithium-ion battery anodes, has a theoretical energy density of 372 milliampere hours per gram (mAh/g). In comparison, silicon has a high theoretical capacity of 4200 mAh/g. To increase the volumetric and gravimetric energy density of lithium-ion batteries, silicon may be used as the active material for the cathode or anode. Silicon anodes may be formed from silicon composites, with more than 50% silicon or more by weight in the anode material on the current collector, for example.

In an example scenario, the anode 101 and cathode 105 store the ion used for the separation of charge, such as lithium. In this example, the electrolyte carries positively charged lithium ions from the anode 101 to the cathode 105 in discharge mode, as shown in FIG. 1A for example, and vice versa through the separator 105 in charge mode. The movement of the lithium ions creates free electrons in the anode 101 which creates a charge at the positive current collector 107B. The electrical current then flows from the current collector through load 109 to the negative current collector 107A. The separator 103 blocks the flow of electrons inside the battery 100, allows the flow of lithium ions, and prevents direct contact between the electrodes.

While battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process costs and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be manipulated by incorporating conductive additives with different morphological properties. 0-dimensional carbon (for example, Super P), and 1-dimensional carbon (for example, vapor-grown carbon fibers, single-walled or multi-walled carbon nanotubes and other 1D carbon structures) and the mixture of the two have previously been incorporated separately into the anode electrode resulting in improved performance of the anode. The synergistic interactions between the two carbon materials may facilitate electrical contact throughout the large volume changes of the silicon anode during charge and discharge. These contact points facilitate the electrical contact between anode material and current collector to mitigate the isolation (island formation) of the electrode material while also improving conductivity in between silicon regions.

FIG. 1B illustrates an example battery management system (BMS) for use in managing operation of batteries. Shown in FIG. 1B is battery management system (BMS) 140.

The battery management system (BMS) 140 may comprise suitable circuitry (e.g., processor 141) configured to manage one or more batteries (e.g., each being an instance of the battery 100 as described with respect with FIG. 1A). In this regard, the BMS 140 may be in communication and/or coupled with each battery 100. In some implementations, a separate processor (e.g., a conventional processor, such as an electronic control unit (ECU), a microcontroller unit (ECU), or the like), or several such separate processors, may be used, and may be configured to handle algorithms or control functions with regards to the batteries. In such implementations, such processor(s) may be connected to the batteries, such as through the processor 141, and thus may be treated as part of the BMS 140 and acting as part of processor 141.

In some embodiments, the battery 100 and the BMS 140 may be in communication and/or coupled with each other, for example, via electronics or wireless communication. In some embodiments, the BMS 140 may be incorporated into the battery 100. Alternatively, in some embodiments, the BMS 140 and the battery 100 may be combined into a common package 150. Further, in some embodiments, the BMS 140 and the battery 100 may be separate devices/components, and may only be in communication with one another when present in the same system. The disclosure is not limited to any particular arrangement, however.

State-of-the-art lithium-ion batteries typically employ a graphite-dominant anode as an intercalation material for lithium. Silicon-dominant anodes, however, offer improvements compared to graphite-dominant Li-ion batteries. Silicon exhibits both higher gravimetric (4200 mAh/g vs. 372 mAh/g for graphite) and volumetric capacities (2194 mAh/L vs. 890 mAh/L for graphite). In addition, silicon-based anodes have a low lithiation/delithiation voltage plateau at about 0.3-0.4V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life. Therefore, silicon anodes require a strong conductive matrix that (a) holds silicon particles in the anode, (b) is flexible enough to accommodate the large volume expansion and contraction of silicon, and (c) allows fast conduction of electrons within the matrix. Binders may be used in anode technologies to maintain the integrity of the anode during excessive volume changes during lithiation.

Although there has been a significant amount of effort to develop silicon anodes, the primary focus of developing these anodes is in dealing with the following three key issues: 1) silicon nanoparticles—the majority of the silicon-based anodes that have high silicon content use silicon nanoparticles to alleviate the large volume expansion. Nano-silicon is expensive and generally requires special processing methods to prepare in large scale, which are not cost effective for large scale battery manufacturing. 2) Carbon additives-silicon-based electrode manufacturers commonly use carbon additives and binders mixed in organic solvents. The use of organic based binders and solvents has challenges associated with the toxicity and high cost. 3) non-conducting binder material—the final anode formulation still contains non conducting polymeric binder that does not contribute to the electrochemical performance. As a result of this “dead weight” of the binder, the improvement of gravimetric energy density of the resulting cells may be limited.

Si is one of the most promising anode materials for Li-ion batteries due to its high specific gravimetric and volumetric capacity (discussed above), and low lithiation potential (<0.4 V vs. Li/Li⁺).

One strategy for overcoming these barriers includes exploring new electrolyte compositions in order to make good use of Si anode-based full cells. Electrolyte compositions should be able to assist in forming a uniform, stable SEI layer on the surface of Si anodes. This layer should have low impedance and be electronically insulating, but ionically conductive to Li-ion. Additionally, the SEI layer should have excellent elasticity and mechanical strength to overcome the problem of expansion and shrinkage of the Si anode volume. On the cathode side, the ideal electrolyte composition should be oxidized preferentially to the solvent molecule in the bare electrolyte, resulting in a protective cathode electrolyte interphase (CEI) film formed on the surface of the cathodes. At the same time, it should help alleviate the dissolution phenomenon of transition metal ions and decrease surface resistance on cathode side. In addition, the physical properties of the electrolyte may also be improved, such as ionic conductivity, viscosity, and wettability.

Thus, the next generation of electrolyte compositions are described herein. These materials may help modify cathode surfaces, forming stable CEI layers, or may form a stable, electronically insulating but ionically conducting SEI layer on the surface of Si anodes. These materials may also increase the electrochemical stability of Li-ion batteries when cycled at higher voltages and help with calendar life of the batteries. In addition, to alleviate battery safety concerns, these materials may impart an increased thermal stability to the organic components of the electrolyte, drive a rise in the flash point of the electrolyte formulations, increase the flame-retardant effectiveness and enhance thermal stability of SEI or CEI layers on the surface of electrodes. Further, the materials may produce one or more of the following benefits: increased cycle life, increased energy density, increased safety, decreased electrolyte consumption and/or decreased gassing.

Lithium-ion battery (LIB) cells are commonly used in power tools, e-bikes, and electric vehicles. However, these batteries can sometimes malfunction, with thermal runaway (TR) being one possible failure mode. Thermal runaway can lead to significant property damage, injury, or even loss of life. LIB cells have a limited tolerance for deviations from their specified temperature and voltage/current ranges. When these parameters are exceeded, it can cause overcharging and increase the risk of thermal runaway. Additionally, if a cell is damaged by debris during an accident, it might also enter a thermal runaway state.

Thermal propagation (TP) is a challenging chain reaction that involves a rapid rise in cell temperature, cell rupture, decomposition, and explosion due to gas release and uncontrolled fire. Thermal runaway in a single cell can quickly spread to adjacent cells, especially in large packs used in e-mobility or energy storage systems. For instance, thermal runaway in a single cell within a vehicle's battery pack could jeopardize the entire vehicle and endanger the occupants. Such failures can result from mechanical impacts, foreign material penetration, or defects in electrical, thermal, or manufacturing processes.

In cells with higher energy densities, such as those containing silicon or lithium metal, the safety concerns are more pronounced. These cells heat up more rapidly due to their lower heat capacity compared to traditional graphite or nickel-based cells. High-nickel cathodes like NMC622, NMC811, NCMA and NCA can exacerbate the issue by releasing oxygen, which accelerates thermal runaway.

To prevent thermal propagation in pouch-type LIB cells, a thermal barrier (i.e. blocking device) may be included inside the cell. Even if thermal runaway occurs in the first cell, a blocking device (BLD) that can prevent the fire from spreading to adjacent cells is needed. A BLD may be composed of insulating heat-resistant materials on films or foils. The heat resistant materials should also possess low thermal conductivity across a wide temperature range to be effective. The main role of the BLD is to delay the heat transfer between cells. In addition to being just an insulating device, the BLD may include materials that absorb heat through reactions or phase changes. Some examples of these materials would be paraffin, polyethylene, polypropylene, Magnesium Hydroxide [Mg(OH)₂], or LiF.

Another way safety can be improved is by including a device inside a cell that can lower the state of charge (SOC) when the temperature rises. Such a device that can lower the SOC of the cell is called a SOC device (SOCD). One way such a SOCD can be made and included in the cell is by stacking Al foil and Cu foil with a low-melting point metal piece attached on Cu wrapped with a separator. The SOCD works synergistically with a BLD since lowering the SOC of a cell takes time and can heat the cell. The BLD allows for more time for a cell to safely lower SOC without heating up. BLD with endothermic materials can retard the heating even more.

The electrolyte is another key component that affects the safety profile of a Li-ion battery system. Most commonly used electrolytes are highly flammable and adversely affect the thermal runaway (TR) and thermal propagation (TP) characteristics of a Li-ion battery system.

In the current invention, novel electrolyte compositions with flame-retardant additives and solvents that reduce the flammability of the electrolyte are disclosed, where the electrolyte has minimal or no impact on the electrochemical performance. Electrolyte compositions comprising electrolyte additives and/or solvents for reduction of thermal propagation in lithium-ion batteries are disclosed. Energy storage devices comprising the electrolyte compositions comprise a first electrode and a second electrode, wherein at least one of the first electrode and the second electrode may be a Si-based electrode, a separator between the first electrode and the second electrode, and the electrolyte composition.

Classes of compounds that may be used as flame-retardant solvents or additives in electrolyte compositions include linear and cyclic ethers, sultones, phosphazenes, phosphates and phosphate esters, hydrofluoroethers, hydrofluorocarbonates, hydrofluorocarbons, perfluoroethers, and perfluorocarbons. These compounds and compositions are described further below.

This disclosure provides better safety, by reducing the risk of or preventing TP at the pack level and thermal runaway at the cell level by the use of lower flammability electrolyte compositions.

This disclosure addresses this issue through the use specific electrolyte compositions. The use of electrolyte compositions for energy storage devices resulting in reduction of pressure evolution in lithium ion batteries is described.

While the technology herein is often described as being incorporated into silicon batteries, the technology also applies to traditional non-silicon batteries and their manufacturing processes.

As the demands for both zero-emission electric vehicles and grid-based energy storage systems increase, lower costs and improvements in energy density, power density, and safety of lithium (Li)-ion batteries are highly desirable. Enabling the high energy density and safety of Li-ion batteries requires the development of high-capacity, and high-voltage cathodes, high-capacity anodes, and accordingly functional electrolytes with high voltage stability, interfacial compatibility with electrodes and safety.

A lithium-ion battery typically includes a separator and/or electrolyte between an anode and a cathode. In one class of batteries, the separator, cathode, and anode materials are individually formed into sheets or films. Sheets of the cathode, separator, and anode are subsequently stacked or rolled with the separator separating the cathode and anode (e.g., electrodes) to form the battery. Typical electrodes include electro-chemically active material layers on electrically conductive metals (e.g., aluminum and copper). Films can be rolled or cut into pieces which are then layered into stacks. The stacks are of alternating electro-chemically active materials with the separator between them.

As discussed above, a lithium-ion battery typically includes a separator and/or electrolyte between an anode and a cathode. Separators may be formed as sheets or films, which are then stacked or rolled with the anode and cathode (e.g., electrodes) to form the battery. The separator may comprise a single continuous or substantially continuous sheet or film, which can be interleaved between adjacent electrodes of the electrode stack. The separator may be configured to facilitate electrical insulation between the anode and the cathode, while still permitting ionic transport. In some embodiments, the separator may comprise a porous material. Functional compounds may be used to modify the separator to prepare different types of functional separators to improve the cycle performance of Li-ion batteries or Li-metal batteries.

Cathode materials may include Lithium Nickel Cobalt Manganese Oxide (NMC (NCM)—including NMC622, NMC811): LiNiₓCo_{y}Mn_{z}O₂, x+y+z=1); Lithium Iron Phosphate (LFP: LiFePO₄/C); Lithium Nickel Manganese Spinel (LNMO: LiNi_{0.5}Mn_{1.5}O₄); Lithium Nickel Cobalt Aluminium Oxide (NCA: LiNiₐCo_{b}Al_{c}O₂, a+b+c=1); Lithium Manganese Oxide (LMO: LiMn₂O₄); Lithium Cobalt Oxide (LCO: LiCoO₂); a quaternary system of Lithium Nickel Cobalt Manganese Aluminum Oxide (NCMA: e.g. Li[Ni_{0.89}Co_{0.05}Mn_{0.05}Al_{0.01}]O₂.; and other Li-rich layer cathodes or similar materials, or combinations thereof.

Among the various cathodes presently available, layered lithium transition-metal oxides such as Ni-rich LiNiₓCo_{y}Mn_{z}O₂ (NCM, 0≤x, y, z<1) or LiNiₓCo_{y}Al_{z}O₂ (NCA, 0≤x, y, z<1) are promising ones due to their high theoretical capacity (˜280 mAh/g) and relatively high average operating potential (3.6 V vs Li/Li⁺). In addition to Ni-rich NCM or NCA cathode, LiCoO₂ (LCO) is also a very attractive cathode material because of its relatively high theoretical specific capacity of 274 mAh g⁻¹, high theoretical volumetric capacity of 1363 mAh cm⁻³, low self-discharge, high discharge voltage, and good cycling performance. Coupling Si anodes with high-voltage Ni-rich NCM (or NCA) or LCO cathodes can deliver more energy than conventional Li-ion batteries with graphite-based anodes, due to the high capacity of these new electrodes. However, both Si-based anodes and high-voltage Ni-rich NCM (or NCA) or LCO cathodes face formidable technological challenges, and long-term cycling stability with high-Si anodes paired with NCM or NCA cathodes has yet to be achieved.

For anodes, silicon-based materials can provide significant improvement in energy density. However, the large volumetric expansion (e.g., >300%) during the Li alloying/dealloying processes can lead to disintegration of the active material and the loss of electrical conduction paths, thereby reducing the cycling life of the battery. In addition, an unstable solid electrolyte interphase (SEI) layer can develop on the surface of the cycled anodes and leads to an endless exposure of Si particle surfaces to the liquid electrolyte. This results in an irreversible capacity loss at each cycle due to the reduction at the low potential where the liquid electrolyte reacts with the exposed surface of the Si anode. In addition, oxidative instability of the conventional non-aqueous electrolyte takes place at voltages beyond 4.5 V, which can lead to accelerated decay of cycling performance. Because of the generally inferior cycle life of Si compared to graphite, only a small amount of Si or Si alloy is used in conventional anode materials.

The cathode (e.g., NCM (or NCA) or LCO) usually suffers from inferior stability and a low capacity retention at a high cut-off potential. The reasons can be ascribed to the unstable surface layer's gradual exfoliation, the continuous electrolyte decomposition, and the transition metal ion dissolution into electrolyte solution; further causes for inferior performance can be: (i) structural changes from layered to spinel upon cycling; (ii) Mn- and Ni-dissolution giving rise to surface side reactions at the graphite anode; and (iii) oxidative instability of conventional carbonate-based electrolytes at high voltage. The major limitations for LCO cathodes are high cost, low thermal stability, and fast capacity fade at high current rates or during deep cycling. LCO cathodes are expensive because of the high cost of Co. Low thermal stability refers to an exothermic release of oxygen when a lithium metal oxide cathode is heated. In order to make good use of Si anode//NCM or NCA cathode, and Si anode//LCO cathode-based Li-ion battery systems, the aforementioned barriers need to be overcome.

As discussed above, Li-ion batteries are being intensively pursued in the electric vehicle markets and stationary energy storage devices. To further improve the cell energy density, high-voltage layered transition metal oxide cathodes, examples including Ni-rich (e.g. NCA, NCM), Li-rich cathodes, and high capacity and low-voltage anodes, such as Si, Ge, etc may be utilized. However, the performance deterioration of full cells, in which these oxides are paired with Si or other high capacity anodes, increases markedly at potentials exceeding 4.30 V, limiting their wider use as high-energy cathode materials. Although a higher Ni content provides a higher specific capacity for Ni-rich NCM or NCA cathodes, it involves surface instability because of the unstable Ni⁴⁺ increase during the charging process. As it is favorable to convert the unstable Ni⁴⁺ into the more stable Ni³⁺ or Ni²⁺, Ni⁴⁺ triggers severe electrolyte decomposition at the electrode/electrolyte interface, leading to the reduction of Ni⁴⁺ and the oxidative decomposition of the electrolytes. Electrolyte decomposition at the electrolyte/electrode interface causes the accumulation of decomposed adducts on the NCM cathode surface. This hinders Li+ migration between the electrolyte and electrode, which in turn results in the rapid fading of the cycling performance. Thus the practical integration of a silicon anode in Li-ion batteries faces challenges such as large volume changes, unstable solid-electrolyte interphase, electrolyte drying out, etc.

In order to increase the volumetric and gravimetric energy density of lithium-ion batteries, silicon may be used as the active material for the cathode or anode. Several types of silicon materials, e.g., silicon nanopowders, silicon nanofibers, porous silicon, and ball-milled silicon, have also been reported as viable candidates as active materials for the negative or positive electrodes. Small particle sizes (for example, sizes in the nanometer range) generally can increase cycle life performance. They also can display very high initial irreversible capacity. However, small particle sizes also can result in very low volumetric energy density (for example, for the overall cell stack) due to the difficulty of packing the active material. Larger particle sizes, (for example, sizes in the micron range) generally can result in higher density anode material. However, the expansion of the silicon active material can result in poor cycle life due to particle cracking. For example, silicon can swell over 300% upon lithium insertion. Because of this expansion, anodes including silicon should be allowed to expand while maintaining electrical contact between the silicon particles.

Cathode electrodes (positive electrodes) described herein may include metal oxide cathode materials, such as Lithium Cobalt Oxide (LiCoO₂) (LCO), Ni-rich oxides, high voltage cathode materials, lithium-rich oxides, nickel-rich layered oxides, lithium-rich layered oxides, high-voltage spinel oxides, and high-voltage polyanionic compounds. Ni-rich oxides and/or high voltage cathode materials may include NCM and NCA. Example of NCM materials include, but are not limited to, LiNi_{0.6}Co_{0.2}Mn_{0.2}O₂ (NCM-622) and LiNi_{0.8}Co_{0.1}Mn_{0.1}O₂(NCM-811). Lithium-rich oxides may include xLi₂Mn₃O₂·(1−x)LiNiₐCo_{b}Mn_{c}O₂. Nickel-rich layered oxides may include LiNi₁₊ₓM₁₋ₓO_{z} (where M=Co, Mn or Al). Lithium-rich layered oxides may include LiNi₁₊ₓM₁₋ₓO₂ (where M=Co, Mn or Ni). High-voltage spinel oxides may include LiNi_{0.5}Mn_{1.5}O₄. High-voltage polyanionic compounds may include phosphates, sulfates, silicates, etc.

In certain embodiments, the positive electrode may be one of NCA, NCM, LMO or LCO. The NCM cathodes include NCM 9 0.5 0.5, NCM811, NCM622, NCM532, NCM433, NCM111, and others. In further embodiments, the positive electrode comprises a lithium-rich layered oxide xLi₂MnO₃·(1−x)LiNiₐCo_{b}Mn_{c}O₂; nickel-rich layered oxide LiNi₁₋ₓMₓO₂ (M=Co, Mn and Al); or lithium rich layered oxide LiNi₁₊ₓM₁₋ₓO₂ (M=Co, Mn and Ni) cathode.

As described herein and in U.S. patent application Ser. Nos. 13/008,800 and 13/601,976, entitled “Composite Materials for Electrochemical Storage” and “Silicon Particles for Battery Electrodes,” respectively, certain embodiments utilize a method of creating monolithic, self-supported anodes using a carbonized polymer. Because the polymer is converted into an electrically conductive and electrochemically active matrix, the resulting electrode is conductive enough that, in some embodiments, a metal foil or mesh current collector can be omitted or minimized. The converted polymer also acts as an expansion buffer for silicon particles during cycling so that a high cycle life can be achieved. In certain embodiments, the resulting electrode is an electrode that is comprised substantially of active material. In further embodiments, the resulting electrode is substantially active material. The electrodes can have a high energy density of between about 500 mAh/g to about 1200 mAh/g that can be due to, for example, 1) the use of silicon, 2) elimination or substantial reduction of metal current collectors, and 3) being comprised entirely or substantially entirely of active material.

As described herein and in U.S. patent application Ser. No. 14/800,380, entitled “Electrolyte Compositions for Batteries,” the entirety of which is hereby incorporated by reference, composite materials can be used as an anode in most conventional Li-ion batteries; they may also be used as the cathode in some electrochemical couples with additional additives. The composite materials can also be used in either secondary batteries (e.g., rechargeable) or primary batteries (e.g., non-rechargeable). In some embodiments, the composite materials can be used in batteries implemented as a pouch cell, as described in further details herein. In certain embodiments, the composite materials are self-supported structures. In further embodiments, the composite materials are self-supported monolithic structures. For example, a collector may be included in the electrode comprised of the composite material. In certain embodiments, the composite material can be used to form carbon structures discussed in U.S. patent application Ser. No. 12/838,368 entitled “Carbon Electrode Structures for Batteries,” the entirety of which is hereby incorporated by reference. Furthermore, the composite materials described herein can be, for example, silicon composite materials, carbon composite materials, and/or silicon-carbon composite materials.

In some embodiments, the largest dimension of the silicon particles can be less than about 40 μm, less than about 1 μm, between about 10 nm and about 40 μm, between about 10 nm and about 1 μm, less than about 500 nm, less than about 100 nm, and about 100 nm. All, substantially all, or at least some of the silicon particles may comprise the largest dimension described above. For example, an average or median largest dimension of the silicon particles can be less than about 40 μm, less than about 1 μm, between about 10 nm and about 40 μm, between about 10 nm and about 1 μm, less than about 500 nm, less than about 100 nm, and about 100 nm. The amount of silicon in the composite material can be greater than zero percent by weight of the mixture and composite material. In certain embodiments, the mixture comprises an amount of silicon, the amount being within a range of from about 0% to about 95% by weight, including from about 30% to about 95% by weight of the mixture. The amount of silicon in the composite material can be within a range of from about 0% to about 35% by weight, including from about 0% to about 25% by weight, from about 10% to about 35% by weight, and about 20% by weight. In further certain embodiments, the amount of silicon in the mixture is at least about 30% by weight; greater than 0% and less than about 95% by weight; or between about 50% and about 95% by weight. Additional embodiments of the amount of silicon in the composite material include more than about 50% by weight, between about 30% and about 95% by weight, between about 50% and about 85% by weight, and between about 75% and about 95% by weight. Furthermore, the silicon particles may or may not be pure silicon. For example, the silicon particles may be substantially silicon or may be a silicon alloy. In one embodiment, the silicon alloy includes silicon as the primary constituent along with one or more other elements.

As described herein, micron-sized silicon particles can provide good volumetric and gravimetric energy density combined with good cycle life. In certain embodiments, to obtain the benefits of both micron-sized silicon particles (e.g., high energy density) and nanometer-sized silicon particles (e.g., good cycle behavior), silicon particles can have an average particle size in the micron range and a surface including nanometer-sized features. In some embodiments, the silicon particles have an average particle size (e.g., average diameter or average largest dimension) between about 0.1 μm and about 30 μm or between about 0.1 μm and all values up to about 30 μm. For example, the silicon particles can have an average particle size between about 0.5 μm and about 25 μm, between about 0.5 μm and about 20 μm, between about 0.5 μm and about 15 μm, between about 0.5 μm and about 10 μm, between about 0.5 μm and about 5 μm, between about 0.5 μm and about 2 μm, between about 1 μm and about 20 μm, between about 1 μm and about 15 μm, between about 1 μm and about 10 μm, between about 5 μm and about 20 μm, etc. Thus, the average particle size can be any value between about 0.1 μm and about 30 μm, e.g., 0.1 μm, 0.5 μm, 1 μm, 5 μm, 10 μm, 15 μm, 20 μm, 25 μm, and 30 μm.

In certain embodiments, graphite particles may be added to the mixture. Advantageously, graphite can be an electrochemically active material in the battery as well as an elastically deformable material that can respond to the volume change of the silicon particles. Graphite is the preferred active anode material for certain classes of lithium-ion batteries currently on the market because it has a low irreversible capacity. Additionally, graphite is softer than hard carbon and can better absorb the volume expansion of silicon additives. In certain embodiments, the largest dimension of the graphite particles is between about 0.5 microns and about 20 microns. All, substantially all, or at least some of the graphite particles may comprise the largest dimension described herein. In further embodiments, an average or median largest dimension of the graphite particles is between about 0.5 microns and about 20 microns. In certain embodiments, the mixture includes greater than 0% and less than about 80% by weight of graphite particles. In further embodiments, the composite material includes about 1% to about 20% by weight graphite particles. In further embodiments, the composite material includes about 40% to about 75% by weight graphite particles.

In certain embodiments, conductive particles which may also be electrochemically active are added to the mixture. Such particles can enable both a more electronically conductive composite as well as a more mechanically deformable composite capable of absorbing the large volumetric change incurred during lithiation and de-lithiation. In certain embodiments, a largest dimension of the conductive particles is between about 10 nanometers and about 7 millimeters. All, substantially all, or at least some of the conductive particles may comprise the largest dimension described herein. In further embodiments, an average or median largest dimension of the conductive particles is between about 10 nm and about 7 millimeters. In certain embodiments, the mixture includes greater than zero and up to about 80% by weight conductive particles. In further embodiments, the composite material includes about 45% to about 80% by weight conductive particles. The conductive particles can be conductive carbon including carbon blacks, carbon fibers, carbon nanofibers, carbon nanotubes, graphite, graphene, etc. Many carbons that are considered as conductive additives that are not electrochemically active become active once pyrolyzed in a polymer matrix. Alternatively, the conductive particles can be metals or alloys including copper, nickel, or stainless steel.

The composite material may also be formed into a powder. For example, the composite material can be ground into a powder. The composite material powder can be used as an active material for an electrode. For example, the composite material powder can be deposited on a collector in a manner similar to making a conventional electrode structure, as known in the industry.

In some embodiments, the full capacity of the composite material may not be utilized during the use of the battery in order to improve battery life (e.g., number charge and discharge cycles before the battery fails or the performance of the battery decreases below a usability level). For example, a composite material with about 70% by weight silicon particles, about 20% by weight carbon from a precursor, and about 10% by weight graphite may have a maximum gravimetric capacity of about 2000 mAh/g, while the composite material may only be used up to a gravimetric capacity of about 550 to about 850 mAh/g. Although, the maximum gravimetric capacity of the composite material may not be utilized, using the composite material at a lower capacity can still achieve a higher capacity than certain lithium-ion batteries. In certain embodiments, the composite material is used or only used at a gravimetric capacity below about 70% of the composite material's maximum gravimetric capacity. For example, the composite material is not used at a gravimetric capacity above about 70% of the composite material's maximum gravimetric capacity. In further embodiments, the composite material is used or only used at a gravimetric capacity below about 60% of the composite material's maximum gravimetric capacity or below about 50% of the composite material's maximum gravimetric capacity.

An electrolyte composition for a lithium-ion battery can include a solvent and a lithium-ion source, such as a lithium-containing salt. The composition of the electrolyte may be selected to provide a lithium-ion battery with improved performance. In some embodiments, the electrolyte may contain an electrolyte additive. As described herein, a lithium-ion battery may include a first electrode, a second electrode, a separator between the first electrode and the second electrode, and an electrolyte in contact with the first electrode, the second electrode, and the separator. The electrolyte serves to facilitate ionic transport between the first electrode and the second electrode. In some embodiments, the first electrode and the second electrode can refer to anode and cathode or cathode and anode, respectively. Electrolytes and/or electrolyte compositions may be a liquid, solid, or gel.

In lithium-ion batteries, the most widely used electrolytes are non-aqueous liquid electrolytes; these may comprise a lithium-containing salt (e.g. LiPF₆) and low molecular weight carbonate solvents as well as various small amounts of functional additives. LiPF₆ holds a dominant position in commercial liquid electrolytes due to its well-balanced properties. However, LiPF₆ has problems such as high reactivity towards moisture and poor thermal stability. These issues are primarily attributed to the equilibrium decomposition reaction of LiPF₆. The P—F bond in LiPF₆ and PF₅ is rather labile towards hydrolysis by inevitable trace amounts of moisture in batteries. Besides, as a strong Lewis acid, PF₅ is also able to initiate reactions with carbonate solvents and causes further electrolyte degradation. Moreover, a temperature rise further accelerates the decomposition reaction of LiPF₆ and consequently promotes subsequent parasitic reactions. This is also a reason for faster aging of current lithium-ion batteries at elevated temperatures, as compared to room temperature.

In some embodiments, the electrolyte for a lithium ion battery may include a solvent comprising a fluorine-containing component, such as a fluorine-containing cyclic carbonate, a fluorine-containing linear carbonate, and/or a fluoroether. In some embodiments, the electrolyte can include more than one solvent. For example, the electrolyte may include two or more co-solvents. In some embodiments, at least one of the co-solvents in the electrolyte is a fluorine-containing compound. In some embodiments, the fluorine-containing compound may be fluoroethylene carbonate (FEC), or difluoroethylene carbonate (F2EC). In some embodiments, the co-solvent may be selected from the group consisting of FEC, ethyl methyl carbonate (EMC), 1,1,2,2-tetrafluoroethyl 2,2,3,3-tetrafluoropropyl ether, difluoroethylene carbonate (F2EC), ethylene carbonate (EC), diethyl carbonate (DEC), dimethyl carbonate (DMC), propylene carbonate (PC), Dimethoxy ethane (DME), and gamma-butyrolactone (GBL), methyl acetate (MA), ethyl acetate (EA), and methyl propanoate. In some embodiments, the electrolyte contains FEC. In some embodiments, the electrolyte contains both EMC and FEC. In some embodiments, the electrolyte may further contain 1,1,2,2-tetrafluoroethyl 2,2,3,3-tetrafluoropropyl ether, EC, DEC, DMC, PC, GBL, and/or F2EC or some partially or fully fluorinated linear or cyclic carbonates, ethers, etc. as a co-solvent. In some embodiments, the electrolyte is free or substantially free of non-fluorine-containing cyclic carbonates, such as EC, GBL, and PC.

In further embodiments, electrolyte solvents may be composed of a cyclic carbonate, such as fluoro ethylene carbonate (FEC), di-fluoroethylene carbonate (DiFEC), Trifluoropropylene carbonate (TFPC), ethylene carbonate (EC), propylene carbonate (PC), etc; a linear carbonate, such as dimethyl carbonate (DMC), diethyl carbonate (DEC), ethyl methyl carbonate (EMC), etc, or other solvents, such as fluorobenzene (FB), methyl acetate, ethyl acetate, or gamma butyrolactone, dimethoxyethane, 1,1,2,2-tetrafluoroethyl 2,2,3,3-tetrafluoropropyl ether, etc.

In some embodiments, the electrolyte composition may comprise a system of solvents (i.e. a solvent, plus one or more co-solvents). The solvents may be fluorinated or non-fluorinated. In some embodiments, the co-solvents may be one or more linear carbonates, lactones, acetates, propanoates and/or non-linear carbonates. In some embodiments, the co-solvents may be one or more carbonate solvents, such as one or more linear carbonates and/or non-linear carbonates, as discussed above. In some embodiments, an electrolyte composition may comprise one or more of EC at a concentration of 5% or more; FEC at a concentration of 5% or more; and/or TFPC at a concentration of 5% or more.

In some embodiments, the solvents in the electrolyte composition include, but are not limited to, one or more of ethyl methyl carbonate (EMC), methyl acetate, dimethyl carbonate (DMC), diethyl carbonate (DEC), gamma butyrolactone, methyl acetate (MA), ethyl acetate (EA), methyl propanoate, fluoro ethylene carbonate (FEC), di-fluoroethylene carbonate (DiFEC), Trifluoropropylene carbonate (TFPC), ethylene carbonate (EC), vinylene carbonate (VC) or propylene carbonate (PC). In further embodiments, the solvents include at least one of one or more of ethyl methyl carbonate (EMC), methyl acetate, dimethyl carbonate (DMC), diethyl carbonate (DEC), gamma butyrolactone, methyl acetate (MA), ethyl acetate (EA), methyl propanoate, along with at least one or more of fluoro ethylene carbonate (FEC), di-fluoroethylene carbonate (DiFEC), Trifluoropropylene carbonate (TFPC), ethylene carbonate (EC), vinylene carbonate (VC) or propylene carbonate (PC).

As used herein, a co-solvent of an electrolyte has a concentration of at least about 10% by volume (vol %). In some embodiments, a co-solvent of the electrolyte may be about 20 vol %, about 40 vol %, about 60 vol %, or about 80 vol %, or about 90 vol % of the electrolyte. In some embodiments, a co-solvent may have a concentration from about 10 vol % to about 90 vol %, from about 10 vol % to about 80 vol %, from about 10 vol % to about 60 vol %, from about 20 vol % to about 60 vol %, from about 20 vol % to about 50 vol %, from about 30 vol % to about 60 vol %, or from about 30 vol % to about 50 vol %.

For example, in some embodiments, the electrolyte may contain a fluorine-containing cyclic carbonate, such as FEC, at a concentration of about 10 vol % to about 60 vol %, including from about 20 vol % to about 50 vol %, and from about 20 vol % to about 40 vol %. In some embodiments, the electrolyte may comprise a linear carbonate that does not contain fluorine, such as EMC, at a concentration of about 40 vol % to about 90 vol %, including from about 50 vol % to about 80 vol %, and from about 60 vol % to about 80 vol %. In some embodiments, the electrolyte may comprise 1,1,2,2-tetrafluoroethyl 2,2,3,3-tetrafluoropropyl ether at a concentration of from about 10 vol % to about 30 vol %, including from about 10 vol % to about 20 vol %.

In some embodiments, the electrolyte is substantially free of cyclic carbonates other than fluorine-containing cyclic carbonates (i.e., non-fluorine-containing cyclic carbonates). Examples of non-fluorine-containing carbonates include EC, PC, GBL, and vinylene carbonate (VC).

In some embodiments, the electrolyte may further comprise one or more additives. As used herein, an additive of the electrolyte refers to a component that makes up less than 10% by weight (wt %) of the electrolyte. In some embodiments, the amount of each additive in the electrolyte may be from about 0.2 wt % to about 1 wt %, 0.1 wt % to about 2 wt %, 0.2 wt % to about 9 wt %, from about 0.5 wt % to about 9 wt %, from about 1 wt % to about 9 wt %, from about 1 wt % to about 8 wt %, from about 1 wt % to about 8 wt %, from about 1 wt % to about 7 wt %, from about 1 wt % to about 6 wt %, from about 1 wt % to about 5 wt %, from about 2 wt % to about 5 wt %, or any value in between. In some embodiments, the total amount of the additive(s) may be from about 1 wt % to about 9 wt %, from about 1 wt % to about 8 wt %, from about 1 wt % to about 7 wt %, from about 2 wt % to about 7 wt %, or any value in between. In other embodiments, the percentages of additives may be expressed in volume percent (vol %). In some embodiments, the additives are present in an amount of 0.1, 0.2, 0.3, 0.4 oe 0.5 percent by weight of the total composition.

In some embodiments, salts may be included in the electrolyte compositions. A lithium-containing salt for a lithium-ion battery may comprise a fluorinated or non-fluorinated salt. In further embodiments, a lithium-containing salt for a lithium-ion battery may comprise one or more of lithium hexafluorophosphate (LiPF₆), lithium tetrafluoroborate (LiBF₄), lithium hexafluoroarsenate monohydrate (LiAsF₆), lithium perchlorate (LiClO₄), lithium bis(trifluoromethanesulfonyl)imide (LiTFSI), lithium bis(fluorosulfonyl)imide (LiFSI), lithium bis(oxalato)borate (LiBOB), lithium difluoro(oxalate)borate (LiDFOB), lithium triflate (LiCF₃SO₃), lithium tetrafluorooxalato phosphate (LTFOP), lithium difluorophosphate (LiPO₂F₂), lithium pentafluoroethyltrifluoroborate (LiFAB), and lithium 2-trifluoromethyl-4,5-dicyanoimidazole (LiTDI), lithium bis(2-fluoromalonato)borate (LiBFMB), lithium 4-pyridyl trimethyl borate (LPTB), lithium 2-fluorophenol trimethyl borate (LFPTB), lithium catechol dimethyl borate (LiCDMB), lithium tetrafluorooxalatophosphate (LiFOP), etc. or combinations thereof. In certain embodiments, a lithium-containing salt for a lithium-ion battery may comprise lithium hexafluorophosphate (LiPF₆). In some embodiments, the electrolyte can have a salt concentration of about 1 moles/L (M). In other embodiments, the salt concentration can be higher than 1M; in further embodiments, the salt concentration can be higher than 1.2M. In some embodiments, the total molarity may be between 0.8M to 2.0M.

In some embodiments of the invention, the electrolyte composition comprises a lithium salt or a combination of lithium salts including but not limited to LiFSI, LiPF₆, LiBF₄, LiTFSI, LiNO₃, LiClO₄ in any combination where the total molarity would lie between 0.8M to 2.0M. The solvent would contain 5-90% of any/any combination of the compounds described herein, and the rest of the solvents would be made up of carbonate or ether-based solvents as described herein.

In some embodiments of the invention, the electrolyte composition has sufficient conductivity to discharge the cell rapidly: conductivity of >3 mS/cm, >4 mS/cm, or, ideally >5 mS/cm while still having some of the flame-retardant features described herein.

The term “alkyl” refers to a straight or branched, saturated, aliphatic radical having the number of carbon atoms indicated. The alkyl moiety may be branched or straight chain. For example, C1-C6 alkyl includes, but is not limited to, methyl, ethyl, propyl, isopropyl, butyl, isobutyl, sec-butyl, tert-butyl, pentyl, isopentyl, hexyl, etc. Other alkyl groups include, but are not limited to heptyl, octyl, nonyl, decyl, etc. Alkyl can include any number of carbons, such as 1-2, 1-3, 1-4, 1-5, 1-6, 1-7, 1-8, 1-9, 1-10, 1-11, 1-12 2-3, 2-4, 2-5, 2-6, 3-4, 3-5, 3-6, 4-5, 4-6 and 5-6. The alkyl group is typically monovalent, but can be divalent, such as when the alkyl group links two moieties together.

The term “fluoro-alkyl” refers to an alkyl group where one, some, or all hydrogen atoms have been replaced by fluorine.

The term “alkylene” refers to an alkyl group, as defined above, linking at least two other groups, i.e., a divalent hydrocarbon radical. The two moieties linked to the alkylene can be linked to the same atom or different atoms of the alkylene. For instance, a straight chain alkylene can be the bivalent radical of —(CH₂)ₙ—, where n is 1, 2, 3, 4, 5, 6, 7, 8, 9, or 10. Alkylene groups include, but are not limited to, methylene, ethylene, propylene, isopropylene, butylene, isobutylene, sec-butylene, pentylene and hexylene.

The term “alkoxy” refers to alkyl group having an oxygen atom that either connects the alkoxy group to the point of attachment or is linked to two carbons of the alkoxy group. Alkoxy groups include, for example, methoxy, ethoxy, propoxy, iso-propoxy, butoxy, 2-butoxy, iso-butoxy, sec-butoxy, tert-butoxy, pentoxy, hexoxy, etc. The alkoxy groups can be further substituted with a variety of substituents described within. For example, the alkoxy groups can be substituted with halogens to form a “halo-alkoxy” group, or substituted with fluorine to form a “fluoro-alkoxy” group.

The term “alkenyl” refers to either a straight chain or branched hydrocarbon of 2 to 6 carbon atoms, having at least one double bond. Examples of alkenyl groups include, but are not limited to, vinyl, propenyl, isopropenyl, 1-butenyl, 2-butenyl, isobutenyl, butadienyl, 1-pentenyl, 2-pentenyl, isopentenyl, 1,3-pentadienyl, 1,4-pentadienyl, 1-hexenyl, 2-hexenyl, 3-hexenyl, 1,3-hexadienyl, 1,4-hexadienyl, 1,5-hexadienyl, 2,4-hexadienyl, or 1,3,5-hexatrienyl. Alkenyl groups can also have from 2 to 3, 2 to 4, 2 to 5, 3 to 4, 3 to 5, 3 to 6, 4 to 5, 4 to 6 and 5 to 6 carbons. The alkenyl group is typically monovalent, but can be divalent, such as when the alkenyl group links two moieties together.

The term “alkenylene” refers to an alkenyl group, as defined above, linking at least two other groups, i.e., a divalent hydrocarbon radical. The two moieties linked to the alkenylene can be linked to the same atom or different atoms of the alkenylene. Alkenylene groups include, but are not limited to, ethenylene, propenylene, isopropenylene, butenylene, isobutenylene, sec-butenylene, pentenylene and hexenylene.

The term “alkynyl” refers to either a straight chain or branched hydrocarbon of 2 to 6 carbon atoms, having at least one triple bond. Examples of alkynyl groups include, but are not limited to, acetylenyl, propynyl, 1-butynyl, 2-butynyl, isobutynyl, sec-butynyl, butadiynyl, 1-pentynyl, 2-pentynyl, isopentynyl, 1,3-pentadiynyl, 1,4-pentadiynyl, 1-hexynyl, 2-hexynyl, 3-hexynyl, 1,3-hexadiynyl, 1,4-hexadiynyl, 1,5-hexadiynyl, 2,4-hexadiynyl, or 1,3,5-hexatriynyl. Alkynyl groups can also have from 2 to 3, 2 to 4, 2 to 5, 3 to 4, 3 to 5, 3 to 6, 4 to 5, 4 to 6 and 5 to 6 carbons. The alkynyl group is typically monovalent, but can be divalent, such as when the alkynyl group links two moieties together.

The term “alkynylene” refers to an alkynyl group, as defined above, linking at least two other groups, i.e., a divalent hydrocarbon radical. The two moieties linked to the alkynylene can be linked to the same atom or different atoms of the alkynylene. Alkynylene groups include, but are not limited to, ethynylene, propynylene, butynylene, sec-butynylene, pentynylene, and hexynylene.

The term “cycloalkyl” refers to a saturated or partially unsaturated, monocyclic, fused bicyclic, bridged polycyclic, or spiro ring assembly containing from 3 to 12, from 3 to 10, or from 3 to 7 ring atoms, or the number of atoms indicated. Monocyclic rings include, for example, cyclopropyl, cyclobutyl, cyclopentyl, cyclohexyl, and cyclooctyl. Bicyclic and polycyclic rings include, for example, norbornane, decahydronaphthalene and adamantane. For example, C3-C8 cycloalkyl includes cyclopropyl, cyclobutyl, cyclopentyl, cyclohexyl, cyclooctyl, and norbornane. As used herein, the term “fused” refers to two rings which have two atoms and one bond in common. For example, in the following structure, rings A and B are fused

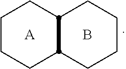

As used herein, the term “bridged polycyclic” refers to compounds wherein the cycloalkyl contains a linkage of one or more atoms connecting non-adjacent atoms. The following structures

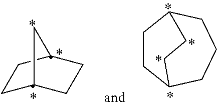 [SMILES: C1CC2CCC1C2 ; C1CC2CCC(C1)CC2]

are examples of “bridged” rings. As used herein, the term “spiro” refers to two rings that have one atom in common and the two rings are not linked by a bridge. Examples of fused cycloalkyl groups are decahydronaphthalenyl, dodecahydro-1H-phenalenyl and tetradecahydroanthracenyl; examples of bridged cycloalkyl groups are bicyclo[1.1.1]pentyl, adamantanyl, and norbornanyl; and examples of spiro cycloalkyl groups include spiro[3.3]heptane and spiro[4.5]decane.

The term “cycloalkylene” refers to a cycloalkyl group, as defined above, linking at least two other groups, i.e., a divalent hydrocarbon radical. The two moieties linked to the cycloalkylene can be linked to the same atom or different atoms of the cycloalkylene. Cycloalkylene groups include, but are not limited to, cyclopropylene, cyclobutylene, cyclopentylene, cyclohexylene, and cyclooctylene.

The term “aryl” refers to a monocyclic or fused bicyclic, tricyclic or greater, aromatic ring assembly containing 6 to 16 ring carbon atoms. For example, aryl may be phenyl, benzyl or naphthyl, preferably phenyl. Aryl groups may include fused multicyclic ring assemblies wherein only one ring in the multicyclic ring assembly is aromatic. Aryl groups can be mono-, di-, or tri-substituted by one, two or three radicals. Preferred as aryl is naphthyl, phenyl, or phenyl mono- or disubstituted by alkoxy, phenyl, halogen, alkyl or trifluoromethyl, especially phenyl or phenyl-mono- or disubstituted by alkoxy, halogen or trifluoromethyl, and in particular phenyl.

The term “arylene” refers to an aryl group, as defined above, linking at least two other groups. The two moieties linked to the arylene are linked to different atoms of the arylene. Arylene groups include, but are not limited to, phenylene.

The term “heteroaryl” refers to a monocyclic or fused bicyclic or tricyclic aromatic ring assembly containing 5 to 16 ring atoms, where from 1 to 4 of the ring atoms are a heteroatom such as N, O, or S. For example, heteroaryl includes pyridyl, indolyl, indazolyl, quinoxalinyl, quinolinyl, isoquinolinyl, benzothienyl, benzofuranyl, furanyl, pyrrolyl, thiazolyl, benzothiazolyl, oxazolyl, isoxazolyl, triazolyl, tetrazolyl, pyrazolyl, imidazolyl, thienyl, or any other radicals substituted, especially mono- or di-substituted, by e.g. alkyl, nitro or halogen. Pyridyl represents 2-, 3- or 4-pyridyl, advantageously 2- or 3-pyridyl. Thienyl represents 2- or 3-thienyl. Quinolinyl represents preferably 2-, 3- or 4-quinolinyl. Isoquinolinyl represents preferably 1-, 3- or 4-isoquinolinyl. Benzopyranyl, benzothiopyranyl represents preferably 3-benzopyranyl or 3-benzothiopyranyl, respectively. Thiazolyl represents preferably 2- or 4-thiazolyl, and most preferred 4-thiazolyl. Triazolyl is preferably 1-, 2- or 5-(1,2,4-triazolyl). Tetrazolyl is preferably 5-tetrazolyl.

Preferably, heteroaryl is pyridyl, indolyl, quinolinyl, pyrrolyl, thiazolyl, isoxazolyl, triazolyl, tetrazolyl, pyrazolyl, imidazolyl, thienyl, furanyl, benzothiazolyl, benzofuranyl, isoquinolinyl, benzothienyl, oxazolyl, indazolyl, or any of the radicals substituted, especially mono- or di-substituted.

The term “heteroalkyl” refers to an alkyl group having from 1 to 3 heteroatoms such as N, O and S. The heteroatoms can also be oxidized, such as, but not limited to, —S(O)— and —S(O)₂—. For example, heteroalkyl can include ethers, thioethers, alkyl-amines and alkyl-thiols.

The term “heteroalkylene” refers to a heteroalkyl group, as defined above, linking at least two other groups. The two moieties linked to the heteroalkylene can be linked to the same atom or different atoms of the heteroalkylene.

The term “heterocycloalkyl” refers to a ring system having from 3 ring members to about 20 ring members and from 1 to about 5 heteroatoms such as N, O and S. The heteroatoms can also be oxidized, such as, but not limited to, —S(O)— and —S(O)₂—. For example, heterocycle includes, but is not limited to, tetrahydrofuranyl, tetrahydrothiophenyl, morpholino, pyrrolidinyl, pyrrolinyl, imidazolidinyl, imidazolinyl, pyrazolidinyl, pyrazolinyl, piperazinyl, piperidinyl, indolinyl, quinuclidinyl and 1,4-dioxa-8-aza-spiro[4.5]dec-8-yl.

The term “heterocycloalkylene” refers to a heterocyclalkyl group, as defined above, linking at least two other groups. The two moieties linked to the heterocycloalkylene can be linked to the same atom or different atoms of the heterocycloalkylene.

The term “optionally substituted” is used herein to indicate a moiety that can be unsubstituted or substituted by one or more substituent. When a moiety term is used without specifically indicating as substituted, the moiety is unsubstituted.

The electrolyte composition described herein may be advantageously utilized within an energy storage device. In some embodiments, energy storage devices may include batteries, capacitors, and battery-capacitor hybrids. In some embodiments, the energy storage device comprises lithium. In some embodiments, the energy storage device may comprise at least one electrode, such as an anode and/or cathode. In some embodiments, at least one electrode may be a Si-based electrode. In some embodiments, the Si-based electrode is a Si-dominant electrode, where silicon is the majority of the active material used in the electrode (e.g., greater than 50% silicon). In some embodiments, the energy storage device comprises a separator. In some embodiments, the separator is between a first electrode and a second electrode.

In some embodiments, the amount of silicon in the electrode material (active material) includes between about 30% and about 95% by weight, between about 50% and about 85% by weight, and between about 75% and about 95% by weight. In other embodiments, the amount of silicon in the electrode material may be at least about 30% by weight; greater than 0% and less than about 95% by weight; or between about 50% and about 95% by weight. In some embodiments, the electrode is silicon dominant (>50% silicon); in other embodiments, the amount of silicon is 70% or more. Furthermore, the silicon particles may or may not be pure silicon. For example, the silicon particles may be substantially silicon or may be a silicon alloy. In one embodiment, the silicon alloy includes silicon as the primary constituent along with one or more other elements.

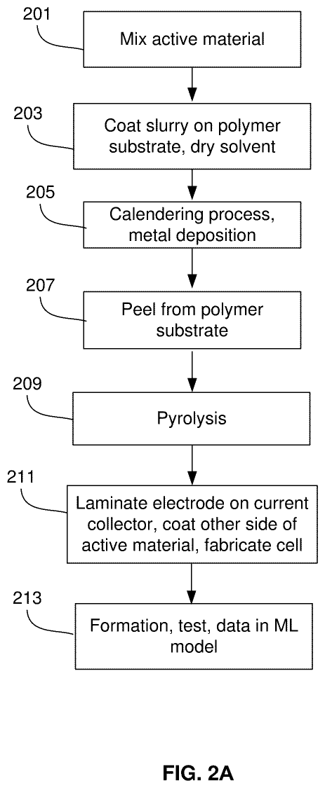

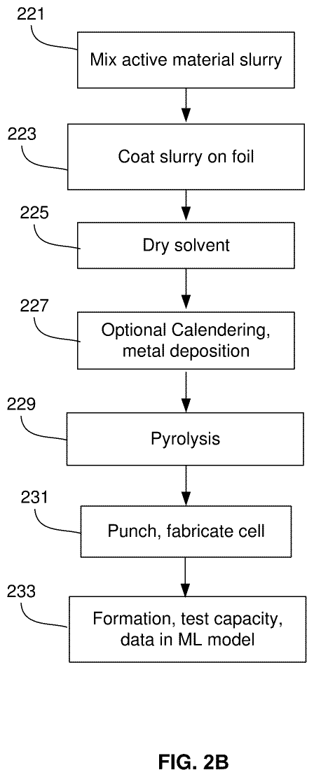

FIG. 2A is a flow diagram of a lamination process for forming a silicon-dominant anode cell, in accordance with an example embodiment of the disclosure. This process employs a high-temperature pyrolysis process on a substrate, layer removal, and a lamination process to adhere the active material layer to a current collector. This strategy may also be adopted by other anode-based cells, such as graphite, conversion type anodes, such as transition metal oxides, transition metal phosphides, and other alloy type anodes, such as Sn, Sb, Al, P, etc.

The raw electrode active material is mixed in step 201. In the mixing process, the active material may be mixed with a binder/resin (such as water-soluble polyimide (PI), polyamideimide (PAI), Phenolic or other water-soluble resins and mixtures and combinations thereof), solvent(s) and other optional additives to form a slurry to use as an electrode coating layer. The materials may comprise carbon nanotubes/fibers, graphene sheets, metal polymers, metals, semiconductors, and/or metal oxides, for example. In one embodiment, silicon powder with a 1-30 or 5-30 μm particle size, for example, may then be dispersed in polyamic acid resin, polyamideimide, or polyimide (15-25% solids in N-Methyl pyrrolidone (NMP) or DI water) at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30-40%. The pH of the slurry can be varied from acidic to basic, which may be beneficial for controlling the solubility, conformation, or adhesion behavior of components of the active material, such as polyamic acid, carboxymethyl cellulose, or polyacrylic acid. Ionic or non-ionic surfactants may be added to facilitate the wetting of the insoluble components of the slurry or the substrates used for coating processes.

The particle size and mixing times may be varied to configure the electrode coating layer density and/or roughness. Furthermore, cathode electrode coating layers may be mixed in step 201, where the electrode coating layer may comprise lithium cobalt oxide (LCO), lithium iron phosphate, lithium nickel cobalt manganese oxide (NMC), Ni-rich lithium nickel cobalt aluminum oxide (NCA), lithium manganese oxide (LMO), lithium nickel manganese spinel, LFP, Li-rich layer cathodes, LNMO or similar materials or combinations thereof, mixed with carbon precursor and additive as described above for the anode electrode coating layer.

In step 203, the slurry may be coated on a substrate. In this step, the slurry may be coated onto a Polyester, polyethylene terephthalate (PET), or Mylar film at a loading of, e.g., 2-4 mg/cm² and then undergo drying to an anode coupon with high Si content and less than 15% residual solvent content. This may be followed by an optional calendering process in step 205, where a series of hard pressure rollers may be used to finish the film/substrate into a smoother and denser sheet of material.

In step 207, the green film may then be removed from the PET, where the active material may be peeled off the polymer substrate, the peeling process being optional for a polypropylene (PP) substrate since PP can leave ˜2% char residue upon pyrolysis. The peeling may be followed by a pyrolysis step 209 where the material may be heated to 600-1250 C for 1-3 hours, cut into sheets, and vacuum dried using a two-stage process (120° C. for 15 h, 220° C. for 5 h).

In step 211, the electrode material may be laminated on a current collector. For example, a 5-20 μm thick copper foil may be coated with polyamide-imide with a nominal loading of, e.g., 0.2-0.6 mg/cm² (applied as a 6 wt % varnish in NMP and dried for, e.g., 12-18 hours at, e.g., 110° C. under vacuum). The anode coupon may then be laminated on this adhesive-coated current collector. In an example scenario, the silicon-carbon composite film is laminated to the coated copper using a heated hydraulic press. An example lamination press process comprises 30-70 seconds at 300° C. and 3000-5000 psi, thereby forming the finished silicon-composite electrode.

In step 213, the cell may be assessed before being subject to a formation process. The measurements may comprise impedance values, open-circuit voltage, and thickness measurements. During formation, the initial lithiation of the anode may be performed, followed by delithiation. Cells may be clamped during formation and/or early cycling. The formation cycles are defined as any type of charge/discharge of the cell that is performed to prepare the cell for general cycling and is considered part of the cell production process. Different rates of charge and discharge may be utilized in the formation steps.

FIG. 2B is a flow diagram of a direct coating process for forming a silicon-dominant anode cell, in accordance with an example embodiment of the disclosure. This process comprises physically mixing the active material, conductive additive, and binder together, and coating it directly on a current collector before pyrolysis. This example process comprises a direct coating process in which an anode or cathode slurry is directly coated on a copper foil using a binder such as CMC, SBR, PAA, Sodium Alginate, PAI, PI and mixtures and combinations thereof.

In step 221, the active material may be mixed with, e.g., a binder/resin (such as PI, PAI or phenolic), solvent (such as NMP, water, other environmentally benign solvents or their mixtures and combinations thereof), and conductive additives. The materials may comprise carbon nanotubes/fibers, graphene sheets, metal polymers, metals, semiconductors, and/or metal oxides, for example. Silicon powder with a 1-30 μm particle size, for example, may then be dispersed in a polymer binder solution at, e.g., 1000 rpm for, e.g., 10 minutes, and then the conjugated carbon/solvent slurry may be added and dispersed at, e.g., 2000 rpm for, e.g., 10 minutes to achieve a slurry viscosity within 2000-4000 cP and a total solid content of about 30-40%.

Furthermore, cathode active materials may be mixed in step 221, where the active material may comprise lithium cobalt oxide (LCO), lithium iron phosphate, lithium nickel cobalt manganese oxide (NMC), lithium nickel cobalt aluminum oxide (NCA), lithium manganese oxide (LMO), lithium nickel manganese spinel, or similar materials or combinations thereof, mixed with a binder as described above for the anode active material.

In step 223, the slurry may be coated on copper foil. In the direct coating process described here, an anode slurry is coated on a current collector with residual solvent, which may be followed by a calendering process for densification and may be further followed by pyrolysis (˜500-800° C.) such that carbon precursors are partially or completely converted into glassy carbon or pyrolytic carbon. Similarly, cathode active materials may be coated on a foil material, such as aluminum, for example. The active material layer may undergo drying in step 225 resulting in reduced residual solvent content. An optional calendering process may be utilized in step 227 where a series of hard pressure rollers may be used to finish the film/substrate into a smoother and denser sheet of material. In step 227, the foil and coating may proceed through a roll press for lamination.

In step 229, the active material may be pyrolyzed by heating to 500-1000° C. such that carbon precursors are partially or completely converted into glassy carbon. Pyrolysis can be done either in roll form or after punching. If done in roll form, the punching is done after the pyrolysis process. The pyrolysis step may result in an anode active material having silicon content greater than or equal to 50% by weight, where the anode has been subjected to heating at or above 400 degrees Celsius. In an example scenario, the anode active material layer may comprise 20 to 95% silicon and in yet another example scenario may comprise 50 to 95% silicon by weight. In instances where the current collector foil is not pre-punched/pre-perforated, the formed electrode may be perforated with a punching roller, for example. The punched electrodes may then be sandwiched with a separator and electrolyte to form a cell. In some embodiments, the anode active material has silicon content greater than or equal to 70% by weight.

In some embodiments, the electrodes are not pyrolyzed.

In step 233, the cell may be assessed before being subject to a formation process. The measurements may comprise impedance values, open-circuit voltage, and thickness measurements. During formation, the initial lithiation of the anode may be performed, followed by delithiation. Cells may be clamped during formation and/or early cycling. The formation cycles are defined as any type of charge/discharge of the cell that is performed to prepare the cell for general cycling and is considered part of the cell production process. Different rates of charge and discharge may be utilized in the formation steps.

In some aspects, energy storage devices such as batteries are provided. In some embodiments, the energy storage device includes a first electrode and a second electrode, wherein at least one of the first electrode and the second electrode is a Si-based electrode. In some embodiments, the energy storage device includes a separator between the first electrode and the second electrode. In some embodiments, the energy storage device includes an electrolyte, which may be provided as an electrolyte composition.

In some embodiments, the second electrode is a Si-dominant electrode. In some embodiments, the second electrode comprises a self-supporting composite material. In some embodiments, the composite material comprises greater than 0% and less than about 95% by weight of silicon particles, and greater than 0% and less than about 90% by weight of one or more types of carbon phases, wherein at least one of the one or more types of carbon phases is a substantially continuous phase that holds the composite material together such that the silicon particles are distributed throughout the composite material.

In some embodiments, the battery may be capable of at least 200 cycles with more than 80% cycle retention when cycling with a C-rate of >2 C cycling between an upper voltage of >4V and a lower cut-off voltage of <3.3V. In other embodiments, the battery may be capable of at least 200 cycles with more than 80% cycle retention when cycling with a C-rate of >2 C cycling between an upper voltage of >4V and a lower cut-off voltage of <3.3V.

Example devices and processes for device fabrication are generally described below, and the performances of lithium-ion batteries with different electrode compositions may be evaluated. Cell properties utilizing electrolyte compositions comprising various salts, additives and solvents may be assessed.

In some embodiments, the electrode composition according to one or more embodiments described herein, may demonstrate one or more of the following advantages: less flammability, high ionic conductivity, and/or survivability at high temperatures. Advantages of batteries comprising electrode compositions as described herein include but are not limited better safety (reducing the risk of or preventing thermal propagation at the pack level and thermal runaway at the cell level) and/or enabling high energy density chemistries such as silicon, lithium metal, high nickel cathodes, etc.

In accordance with the disclosure, linear and cyclic ether, sultone, phosphazene, phosphate (including phosphate ester), phosphite, fluorophosphite hydrofluoroether, hydrofluorocarbonate, hydrofluorocarbon, perfluoroether, and perfluorocarbon compounds may be used as components of electrolyte compositions (as solvents, additives or both). In some embodiments, the compounds may be represented by the general and specific structures below and may be used singly or together in combinations to create electrolyte compositions. In some embodiments, one or more phosphorous containing (phosphorus-based) compounds such as a phosphazene, phosphate (including phosphate ester), phosphite, and/or fluorophosphate compound are used in the electrolyte composition to reduce thermal propagation of an energy storage device. In other embodiments, a hydrofluoroether solvent is used in the electrolyte composition to reduce thermal propagation of an energy storage device.

In accordance with the disclosure, phosphorous-based compounds such as phosphazene and phosphate ester compounds may be used as electrolyte additives or co-solvents. General structures are shown below:

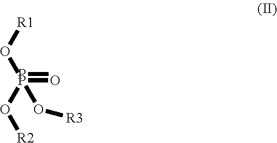

In structures (I) and (Il) R1-R6 may be any combination of the following moieties: F, Cl, Br, CH₃, CH₂R, CHRR′, CRR′R″, CF₃, CF₂R, CHFR, CH₂F, OCH₃, OCH₂R, OCHRR′, OCRR′R″, NHR, NRR′, COR, CONRR′, COOR (where R, R′, R″ can be any alkyl group, which may be partially or fully fluorinated).

Specific examples of phosphazene and phosphate ester compounds include but are not limited to the following:

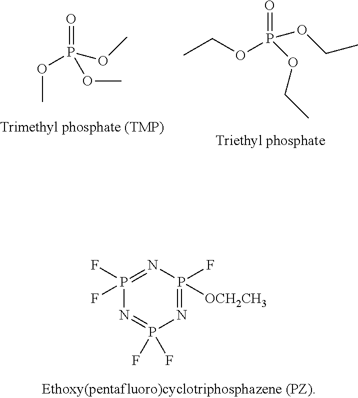

Specific examples of fluorinated phosphate ester compounds include but are not limited to the following:

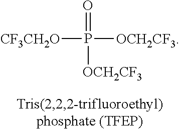

Specific examples of other phosphate compounds include but are not limited to the following:

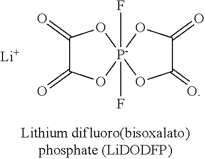 [SMILES: [Li+] ; O=C1O[P-]2(F)(F)(OC1=O)OC(=O)C(=O)O2]

In accordance with the disclosure, the electrolyte composition may comprise a hydrofluoroether solvent.

Examples of hydrofluoroether solvents include but are not limited to the following:

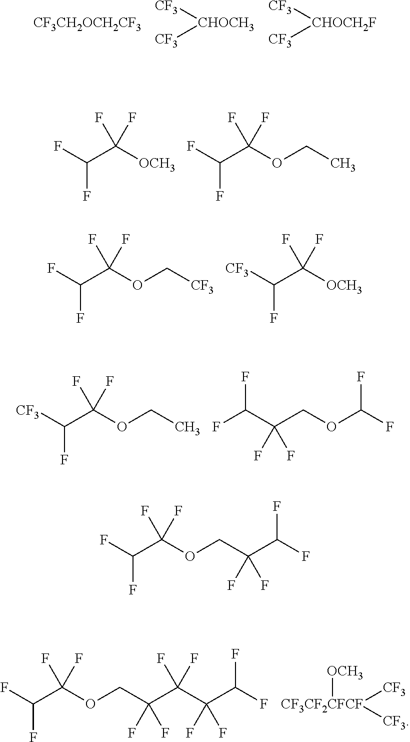

In some embodiments, an energy storage device may comprise the hydrofluoroether solvents above as part of a lower flammability electrolyte composition. The energy storage device may comprise a first electrode and a second electrode, where one or both of the first electrode and the second electrode is a Si-based electrode; a separator between the first electrode and the second electrode; and an electrolyte composition, where the electrolyte composition reduces thermal propagation; and where the electrolyte composition comprises one or more solvents, one or more lithium-containing salts, and one or more optional additives; and where the solvent comprises one or more hydrofluoroether solvents.

In accordance with the disclosure, ether-based or sulfonamide solvents may also be used in electrolyte compositions, including but not limited to any/any combination of the following solvents: (Schemes 1-4). General structures are shown below:

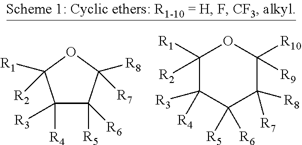

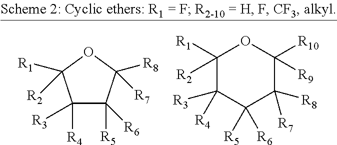

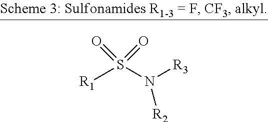

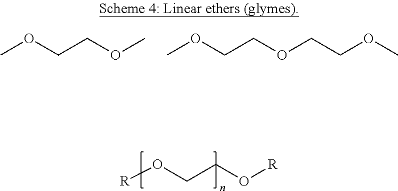

In accordance with the disclosure, sultone compounds may be used as electrolyte additives. Examples of sultones include but are not limited to the following:

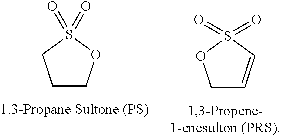 [SMILES: O=S1(=O)CCCO1 ; O=S1(=O)C=CCO1]

Further in accordance with the disclosure, an electrolyte composition may comprise any/any combination of the compounds described above in combination with any carbonate-based solvent system including but not limited to EC, FEC, PC, EMC, DEC, DMC, etc.

Thermal propagation tests were performed on 13-layer (2 Ah) NCM811|Si pouch cells with a passive thermoresponsive shorting device containing the following 5 electrolytes, as shown in Table 1.

TABLE 1

| | Salt | | Additives | Conductivity |
|---|---|---|---|---|
| EL ID | composition | Solvents | (wt. %) | (mS/cm) |
| Control- | 0.8M LiFSI + | FEC/EMC/FB (12/73/15 | 0.4% PS + | 7.262 |
| EL | 0.7M LiPF6 | vol %) | 0.3% LiDODFP + | |
| | | | 0.2% PRS | |
| EL-1 | 1.0M LiPF6 | FEC/EMC/PZ/D7 | | 1.596 |
| | | (15/15/25/45 vol %) | | |
| EL-2 | 0.8M LiFSI + | FEC/EMC/PZ/TMP | | 1.060 |
| | 0.2M LiPF6 | (15/15/25/45 vol %) | | |
| EL-3 | 1M LiFSI + | FEC/EMC/PZ/D7 | | 3.951 |
| | 0.2M LiPF6 | (15/40/25/20 vol %) | | |
| EL-4 | 1.1M LiFSI + | FEC/EMC/PZ/D7 | | 5.070 |
| | 0.2M LiPF6 | (15/50/15/20 vol %) | | |

D7 in Table 1 is the hydrofluoroether solvent (as discussed above) 1,1,2,2-Tetrafluoroethyl-2,2,3,3-tetrafluoropropyl ether, as shown below.

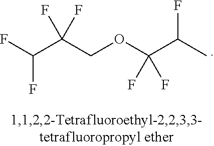

In some embodiments, D7 is present in the electrolyte composition at a concentration of 15-90% of the solvent by volume.

In Table 1, PS, PRS, LiDODFP, LiFSI, TMP and PZ are defined as above. FEC, FB and EMC are fluoroethylene carbonate, fluorobenzene and ethyl methyl carbonate respectively.

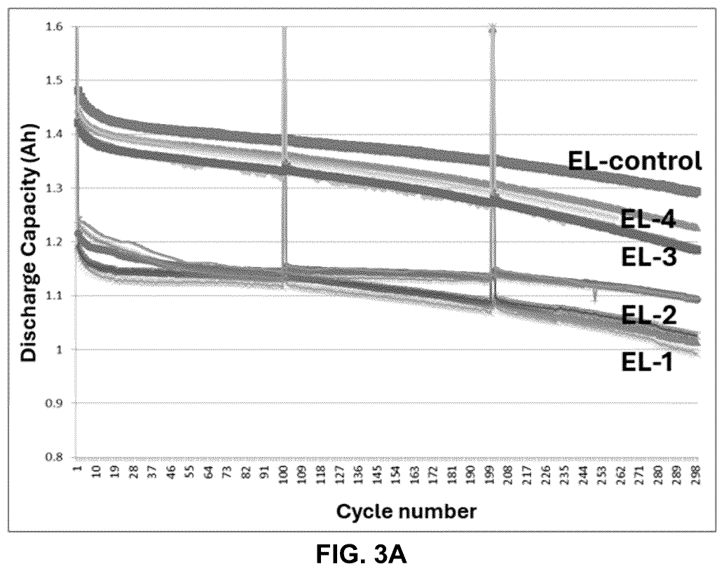

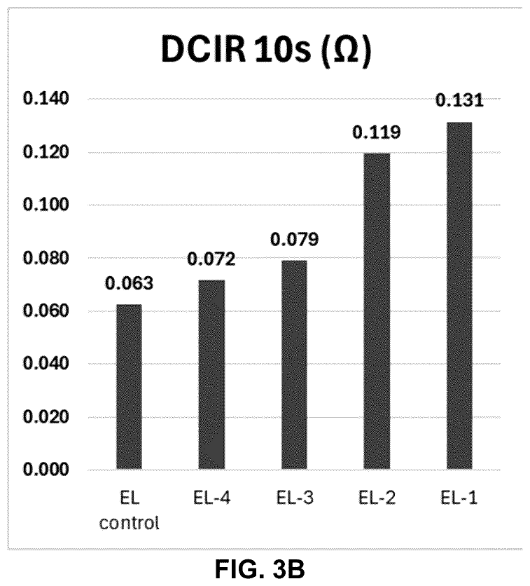

FIG. 3A shows the 300 cycle evaluation results with 4 C charging and 0.5 C discharging using the electrolyte in Table 1. Since the cycle condition was 4 C fast charging, EL-1, which had the lowest electrolyte conductivity, showed the lowest discharge capacity. The capacity maintenance rate at 300 cycles was 83% to 89%. The 10 second DCIR at SOC 100% are shown in FIG. 3B. The DCIR results match well with the electrolyte conductivity measurement results in Table 1.

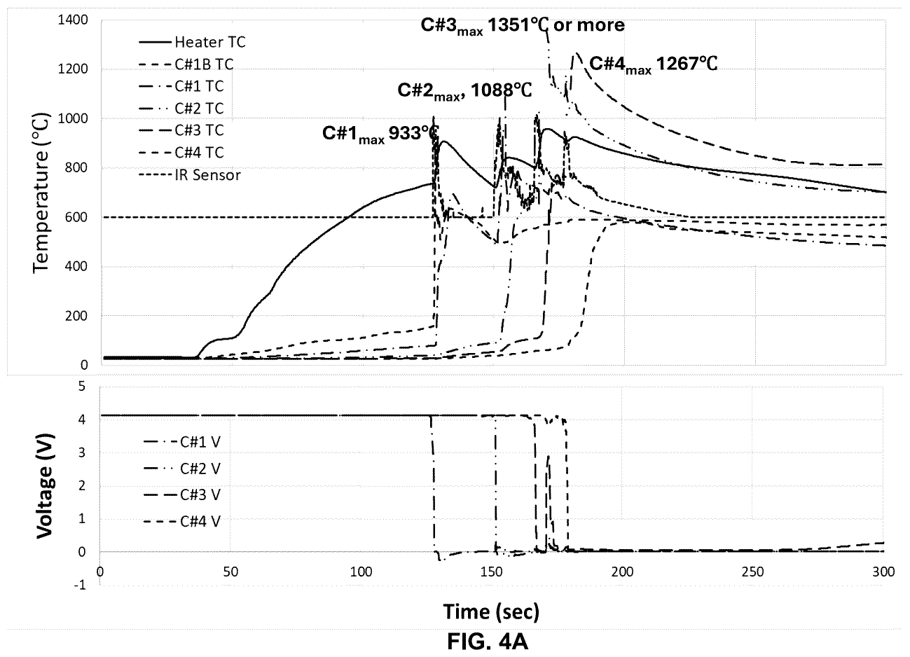

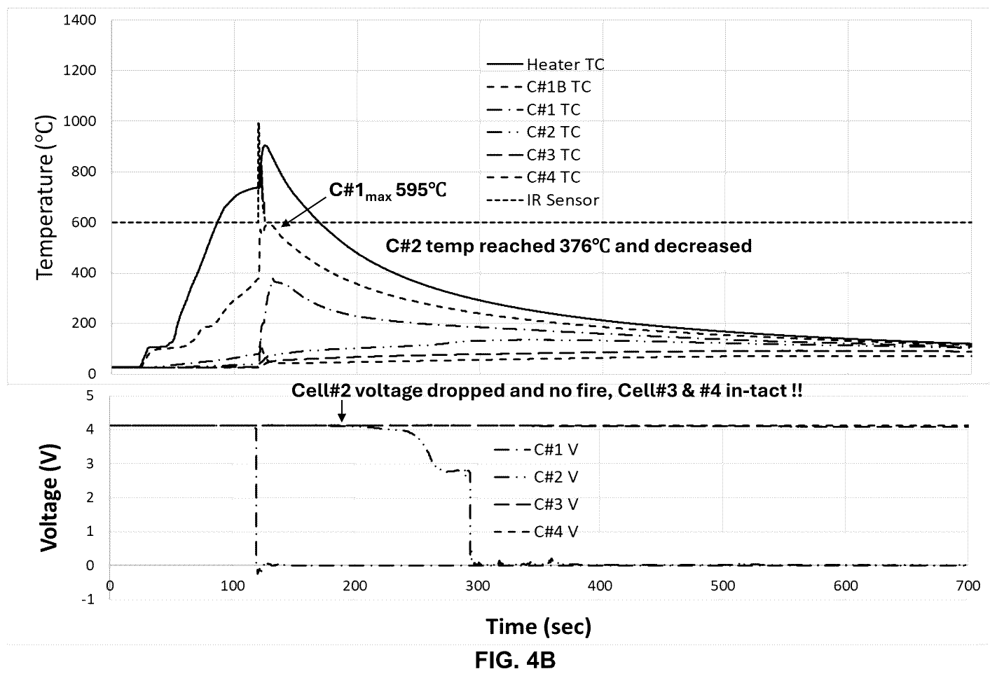

FIGS. 4A and 4B are a comparison of thermal propagation experiment results for cells containing the following electrolytes: (a) Control electrolyte (FIG. 4A) and (b) EL-4 (FIG. 4B) as defined in Table 1. A thermocouple (C1Back) is placed on back side of cell 1 (directly on the heater), thermocouples on C1-C4 are placed in middle, on top of cell, between the cells.

FIGS. 4A and 4B show the results of the thermal propagation test for cells containing the flammable control electrolyte (FIG. 4A) and the flame-retardant electrolyte (EL) (EL-4) (FIG. 4B). It can be seen that the cells containing the control EL, all 4 cells undergo thermal runaway within 20 seconds once cell #1 is triggered. Specifically, the flame of the ignition cell continues, adjacent cells ignite in succession, causing a chain reaction, and the thermal propagation time to the 4^{th} cell is 20 seconds. However, when a flame-retardant electrolyte (EL-4) was used, the flame from the trigger cell was self-extinguished in a short duration before it could trigger the adjacent cells, thereby preventing propagation (thermal propagation was prevented).

In regards to EL-4, without being bound by theory, it is believed that the electrolyte, in combination with SOC reduction, may have enough conductivity to allow SOC reduction to work vs. other electrolytes that may be less flame-resistant but have higher resistance. Additionally, the cells with the other electrolyte may not have had enough time to reduce SOC until the cell hit critical temperature.

Specifically with respect to FIG. 4A, when using a typical electrolyte, the flame of the ignition cell causes adjacent cells to ignite in succession, causing a chain reaction, and the thermal propagation time to the 4^{th} cell is 20 seconds. However, when using flame retardant electrolyte, as shown in FIG. 4B, the flames of the ignition cell was extinguished in a short time and thermal propagation is prevented. Note that in both cases the cells were equipped with SOCD and BLD devices as described above.

When combined with a SOCD, it is important for the electrolyte composition to have sufficient conductivity to discharge the cell rapidly. Ideally, the electrolyte will have conductivity of >3 mS/cm, >4 mS/cm, or, ideally >5 mS/cm while still having at least some flame-retardant features.

Further with respect to EL-4, the amount of PZ is a critical factor in the formulation. Higher amounts improve safety but also negatively impact electrolyte conductivity. Therefore a balanced formulation with advantageous properties contains somewhere between 10-40% PZ.

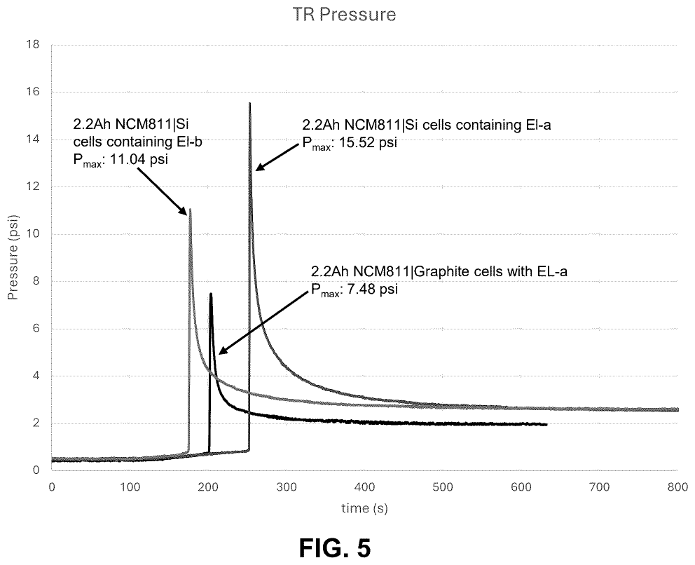

The pressure evolution during thermal runaway (TR) is a key metric that is used to assess the safety profile of a Li-ion battery. Si dominant cells with high Ni cathodes tend to exhibit significantly higher TR pressure evolution compared to conventional Graphite cells as seen in FIG. 5. The electrolytes are shown in Table 2:

TABLE 2

| EL | Salt | | |
|---|---|---|---|
| ID | composition | Solvents | Additives (wt. %) |
| EL-a | 0.8M LiFSI + | FEC/EMC/FB | 0.4% PS + 0.3% |
| | 0.7M LiPF6 | (12/73/15 vol %) | LiDODFP + 0.2% PRS |
| EL-b | 1M LiPF6 | FEC/EMC/TFEP | — |
| | | (15/25/60 vol %) | |

The pressure evolution was measured during thermal runaway (TR) in NCM811|Si cells (13-layer: 2.2 Ah) with different electrolytes and it was found that incorporation of a flame-retardant phosphate ester solvent (TFEP: Tris(2,2,2-trifluoroethyl) phosphate in EL-b) was able to reduce the pressure evolution significantly compared to a conventional electrolyte (EL-a) by ˜30% (Pmax: 11.04 psi vs 15.52 psi). All TR pressure evaluation measurements were conducted in a sealed pressure chamber filled with Argon. In each case, the cell inside the chamber was heated using a 80 W heater until TR was triggered.

TFEP is a phosphate ester that is fluorinated and has the structure shown below:

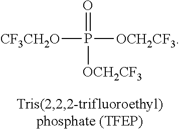

Formulations with TFEP content >20% vol % are most beneficial in lowering Pmax (See Pmax for El-g,i,j compared to EL-a in Table 3 below). In some embodiments, phosphate ester solvents, including but not limited to TFEP. are present in amounts of about 20 to about 90% by volume.

In Table 2, PS, PRS, LiDODFP, LiFSI, and TFEP are defined as above. FEC, FB and EMC are fluoroethylene carbonate, fluorobenzene and ethyl methyl carbonate respectively.

With respect to salts and their concentration, salts such as LiPF₆ and LiBF₄ are the most beneficial for safety while sulfonamide based salts like LiFSI and LiTFSI lead to more exothermic outcomes during TR and should be minimized. In some embodiments, LiPF₆ and/or LiBF₄ are utilized in concentrations up to about 2M and can be used in conjunction with other salts. See also below.

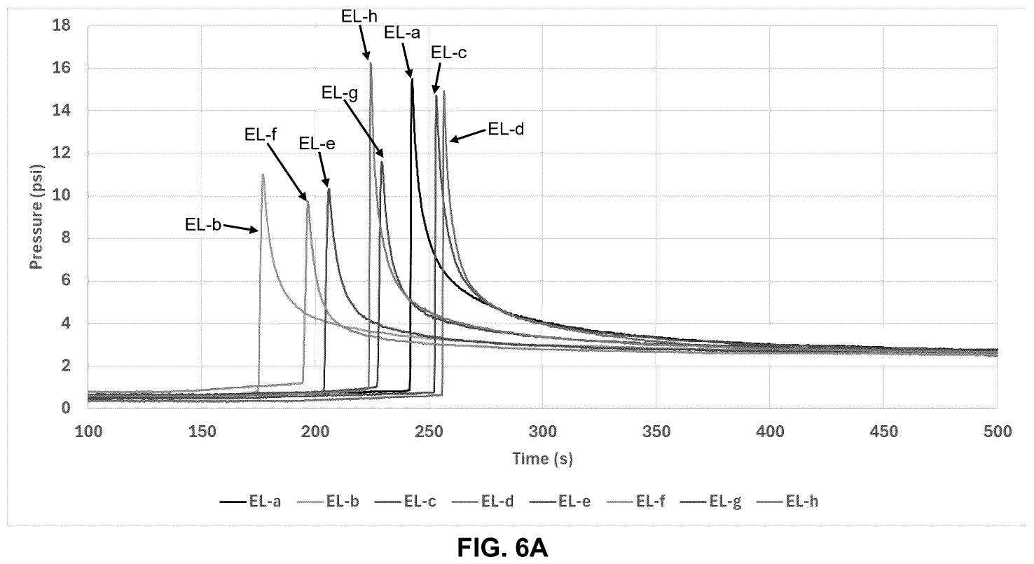

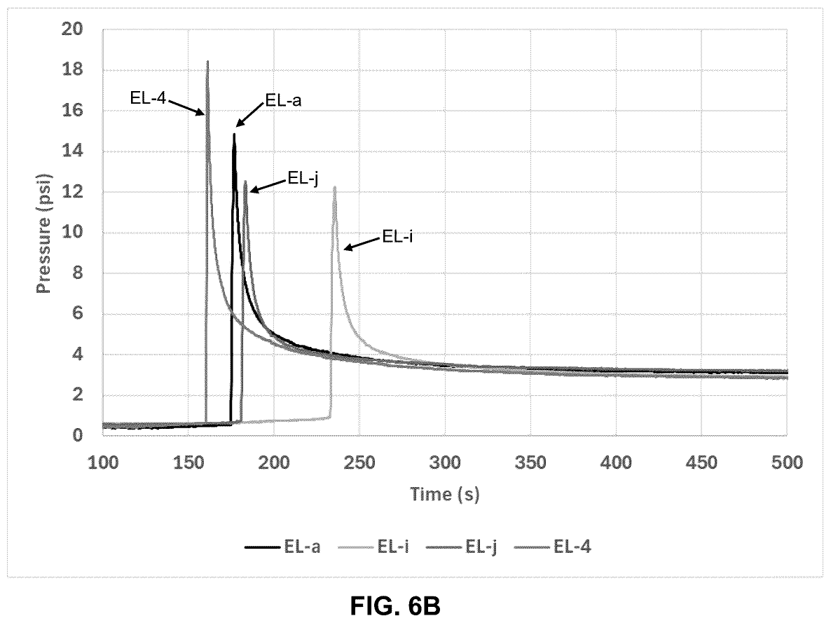

In addition to EL-b, several other electrolyte formulations containing flame-retardant solvents have been found to reduce TR pressure (Pmax) as seen in Table 3 and FIGS. 6A & 6B. The Li-salt used has a significant impact on Pmax. This is demonstrated by comparing Pmax of cells with EL-d and EL-e both of which contain the same solvent system and salt molarity but different salt composition: 0.75M LiTFSI+0.05M LiPF₆ and 0.8M LiPF₆ respectively. EL-d which contains LiTFSI shows much higher Pmax than EL-e which contains only LiPF₆. Therefore, incorporation of LiTFSI in the EL formulation leads to more aggressive thermal runaway outcome.

Similarly, EL-4 which despite containing a solvent system with 35 vol % flame-retardant/low flammability solvents (PZ, D7) but high LiFSI concentration shows the highest Pmax among all electrolytes in Table 1 due to the high LiFSI content (1.1M). Therefore, the amount of LiTFSI and LiFSI in the EL may be reduced or avoided in order to improve the safety profile of the electrolyte system. This may be due to the fact that, unlike LiPF₆ and LiBF₄ which decompose endothermically, FSI and TFSI based salts decompose exothermically at high temperatures and the decomposition products (SOx, NOx, etc.) can further react exothermically with the organic solvents and other components of the cell releasing significantly higher amount of energy than simpler inorganic salts like LiPF₆ and LiBF₄. This may be generalized to most sulfonamide-based salts and also sulfonamide-based ionic liquids including commonly used ones like Lithium Bis(pentafluoroethanesulfonyl)imide, 1-Ethyl-3-methylimidazolium bis(fluorosulfonyl)imide, 1-Ethyl-3-methylimidazolium bis(trifluoromethylsulfonyl)imide, 1-butyl-1-methylpyrrolidinium bis(trifluoromethanesulfonyl)imide, 1-butyl-1-methylpyrrolidinium bis(fluorosulfonyl)imide, etc. Furthermore, salts like LiNO₃ and LiClO₄ that are oxidizers should also be avoided.

Another important finding is that between the two exemplary phosphorous-based flame-retardant solvents of PZ and TFEP, both solvents are beneficial in reducing Pmax, however, PZ is more effective as seen by comparing Pmax of EL-e (60 vol % PZ) with EL-g (90 vol % TFEP). This is likely due to PZ containing fewer combustible —(CH₂)— groups in its molecular structure compared to TFEP and also due to the higher % of P and F atoms. In some embodiments, PZ can be used in conjunction with TFEP.

Classes of phosphorous-based flame-retardant solvent systems that may be considered as co-solvents to improve the safety profile of the electrolyte system may include phosphate esters, phosphites, halo-phosphate esters, halo-phosphites and phosphazines as depicted in Scheme 5 below. The above classes of compounds maybe either cyclic or linear. Among them, compounds that possess lower number of combustible alkyl groups and higher proportion of P/F atoms would be considered most attractive. High levels of fluorination unfortunately result in higher cost and also increased viscosity and lower solvation ability which would impact conductivity of the electrolyte and therefore a balance should be struck while choosing the co-solvent based on the design requirements.

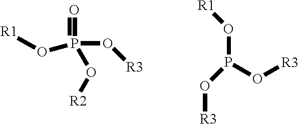

where R1-3 can be any combination of CH₃, CF₃, or any C1-C10 alkyl/fluoroalkyl group (perfluorinated/partially fluorinated) such as CH₂CF₃, CF₂CF₃, etc.

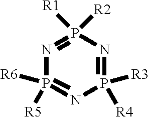

where R1-6 can be any combination of F, CH₃, CF₃, R, OR, or any C1-C10 alkyl/fluoroalkyl (perfluorinated/partially fluorinated) such as CH₂CF₃, CF₂CF₃, etc. and, where R denotes any C1-C10 alkyl/fluoroalkyl (perfluorinated/partially fluorinated).

### Scheme 5: Family of Flame-Retardant Solvents

In some embodiments, an energy storage device may comprise the phosphorous based compounds in Scheme 5 as part of a lower flammability electrolyte composition. The energy storage device may comprise a first electrode and a second electrode, where one or both of the first electrode and the second electrode is a Si-based electrode; a separator between the first electrode and the second electrode; and an electrolyte composition, where the electrolyte composition reduces thermal propagation; and where the electrolyte composition comprises one or more solvents, one or more lithium-containing salts, and one or more optional additives; and where the solvent comprises one or more phosphorous-based compounds.

### Flame-Retardant Electrolyte (FREL) Formulations:

The overall flame-retardant electrolyte formulation (FREL) may comprise any combination of Li salts: lithium bis(fluorosulfonyl)imide (LiFSI), lithium hexafluorophosphate (LiPF₆), lithium tetrafluoroborate (LiBF₄), bis(trifluoromethanesulfonyl)imide (LiTFSI), lithium nitrate (LiNO₃), lithium perchlorate (LiClO₄), Lithium difluoro(oxalato)borate (LiDFOB) and Lithium bis(oxalato)borate (LiBOB) wherein either LiPF₆ or LiBF₄ or a combination of the two are the major components with their combined molarity ranging from about 0.8-2M with other salts making up <0.5M.

The solvent system for the FREL may comprise one or any combination of FEC, EC, PC DFEC, γ-Butyrolactone, δ-Valerolactone that make up 0-40% of the solvent by volume. The solvent may also comprise one or any combination of solvents defined in Scheme 5 that make up 15-90% of the solvent by volume and the rest of the solvent system may include one or any combination of DMC, EMC, DEC, methyl acetate, ethyl acetate, fluorobenzene, hydrofluoroethers, etc. or any combination of solvents described in Schemes 1-4.

The FREL may also include a range of additives as described herein.

In some embodiments, FREL formulations may contain 0.8-2M LiPF₆ in a solvent system comprising 5-15 vol % FEC, 15-90 vol % of PZ, TFEP or any combination of solvents defined in Scheme 5 while the rest of the solvent system would comprise one or any combination of DMC, EMC, DEC, methyl acetate, ethyl acetate, fluorobenzene, etc., and optionally containing one or more additives. Various example embodiments are shown in Table 3.

Pmax values of different electrolyte formulations is shown in Table 3. (Note that Design A and B are both Si-dominant cells and have identical cell components except for the anode design).

TABLE 3

| | Electrolyte | | | |
|---|---|---|---|---|
| Cell design | ID | Salt | Solvents | Pmax (psi) |
| Design-A | EL-a | 0.8M LiFSI + 0.7M | FEC/EMC/FB | 15.52 |
| | | LiPF6 | (12/73/15 vol %) | |
| | EL-b | 1M LiPF6 | FEC/EMC/TFEP | 11.04 |
| | | | (15/25/60 vol %) | |
| | EL-c | 0.75M LiTFSI + | FEC/EMC/PZ (5/15/80 | 14.72 |
| | | 0.05M LiPF6 | vol %) | |
| | EL-d | 0.75M LiTFSI + | FEC/EMC/PZ | 14.94 |
| | | 0.05M LiPF6 | (10/30/60 vol %) | |
| | EL-e | 0.8M LiPF6 | FEC/EMC/PZ | 10.34 |
| | | | (10/30/60 vol %) | |
| | EL-f | 0.8M LiPF6 | EMC/PZ (40/60 vol %) | 9.76 |
| | EL-g | 0.8M LiPF6 | FEC/EMC/TFEP | 11.60 |
| | | | (5/5/90 vol %) | |
| | EL-h | 0.75M LiTFSI + | FEC/EMC/TFEP | 16.26 |
| | | 0.05M LiPF6 | (5/5/90 vol %) | |
| Design-B | EL-a | 0.8M LiFSI + 0.7M | FEC/EMC/FB | 14.88 |
| | | LiPF6 | (12/73/15 vol %) | |
| | EL-4 | 1.1M LiFSI + 0.2M | FEC/EMC/PZ/D7 | 18.42 |
| | | LiPF6 | (15/50/15/20 vol %) | |
| | EL-i | 1M LiPF6 | FEC/EMC/TFEP | 12.26 |
| | | | (10/30/60 vol %) | |
| | EL-j | 1M LiPF6 | FEC/EMC/TFEP | 12.56 |
| | | | (10/70/20 vol %) | |

FIG. 6A shows TR Pressure evolution of cell design-A with different electrolytes (Note that Design A and B are both Si-dominant cells and have identical cell components except for the anode design) and FIG. 6B shows TR Pressure evolution of cell design-B with different electrolytes (Note that Design A and B are both Si-dominant cells and have identical cell components except for the anode design).

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a battery, circuitry, or a device is “operable” to perform a function whenever the battery, circuitry, or device comprises the necessary hardware and code (if any is necessary) or other elements to perform the function, regardless of whether performance of the function is disabled or not enabled (e.g., by a user-configurable setting, factory trim, configuration, etc.).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. An energy storage device comprising:
a first electrode and a second electrode, wherein one or both of the first electrode and the second electrode is a Si-based electrode;
a separator between the first electrode and the second electrode; and
an electrolyte composition, wherein said electrolyte composition reduces thermal propagation; and
wherein said electrolyte composition comprises one or more solvents, one or more lithium-containing salts, and one or more optional additives; and
wherein said solvent comprises one or more phosphorous-based compounds.

2. The energy storage device of claim 1, wherein said one or more phosphorous-based compound is of the structure: 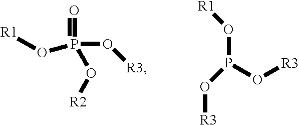
where R1-3 can be any combination of CH₃, CF₃, or any C1-C10 alkyl/fluoroalkyl group (perfluorinated/partially fluorinated);
or 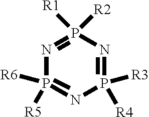
where R1-6 can be any combination of F, CH₃, CF₃, R, OR, or any C1-C10 alkyl/fluoroalkyl (perfluorinated/partially fluorinated) and where R denotes any C1-C10 alkyl/fluoroalkyl (perfluorinated/partially fluorinated).

3. The energy storage device of claim 2, wherein said one or more phosphorous-based compound is a phosphazene compound of structure: 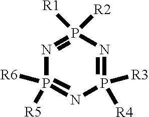
where R1-6 can be any combination of F, CH₃, CF₃, R, OR, or any C1-C10 alkyl/fluoroalkyl (perfluorinated/partially fluorinated) and where R denotes any C1-C10 alkyl/fluoroalkyl (perfluorinated/partially fluorinated).

4. The energy storage device of claim 1, wherein said one or more phosphorous-based compound is present in a concentration of 15-90 vol %.

5. The energy storage device of claim 1, wherein said electrolyte composition further comprises carbonate-based solvent system.

6. The energy storage device of claim 5, wherein said carbonate-based solvent system comprises one or more of Ethylene Carbonate (EC), Fluoroethylene Carbonate (FEC), Propylene Carbonate (PC), Dimethyl Carbonate (DMC), Ethyl Methyl Carbonate (EMC), and Diethyl Carbonate (DEC).

7. The energy storage device of claim 1, wherein said one or more lithium-containing salts are selected from the group consisting of lithium bis(fluorosulfonyl)imide (LiFSI), lithium hexafluorophosphate (LiPF₆), lithium tetrafluoroborate (LiBF₄), bis(trifluoromethanesulfonyl)imide (LiTFSI), lithium nitrate (LiNO₃), lithium perchlorate (LiClO₄), Lithium difluoro(oxalato)borate (LiDFOB) and Lithium bis(oxalato)borate (LiBOB).

8. The energy storage device of claim 7, wherein the amounts of said one or more lithium-containing salts comprise a majority of either LiPF₆ or LiBF₄ or a combination of the two.

9. The energy storage device of claim 8, wherein the combined molarity of LiPF₆ or LiBF₄ or a combination of the two ranges from about 0.8-2M.

10. The energy storage device of claim 9, further comprising other salts making up <0.5M.

11. An energy storage device comprising:
a first electrode and a second electrode, wherein one or both of the first electrode and the second electrode is a Si-based electrode;
a separator between the first electrode and the second electrode; and
an electrolyte composition, wherein said electrolyte composition reduces thermal propagation; and
wherein said electrolyte composition comprises one or more solvents, one or more lithium-containing salts, and one or more optional additives; and
wherein said solvent comprises at least one hydrofluoroether solvent.

12. The energy storage device of claim 11, wherein said hydrofluoroether solvent comprises one or more of the following compounds:

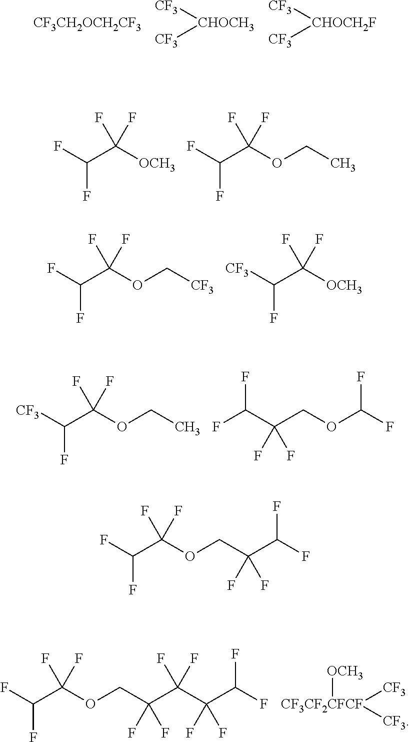

13. The energy storage device of claim 11, wherein said hydrofluoroether solvent is present in a concentration of 15-90 vol %.

14. The energy storage device of claim 11, wherein said electrolyte composition further comprises a phosphazene compound.

15. The energy storage device of claim 11, wherein said electrolyte composition further comprises carbonate-based solvent system.

16. The energy storage device of claim 15, wherein said carbonate-based solvent system comprises one or more of Ethylene Carbonate (EC), Fluoroethylene Carbonate (FEC), Propylene Carbonate (PC), Dimethyl Carbonate (DMC), Ethyl Methyl Carbonate (EMC), and Diethyl Carbonate (DEC).

17. The energy storage device of claim 1, wherein said one or more lithium-containing salts are selected from the group consisting of lithium bis(fluorosulfonyl)imide (LiFSI), lithium hexafluorophosphate (LiPF₆), lithium tetrafluoroborate (LiBF₄), bis(trifluoromethanesulfonyl)imide (LiTFSI), lithium nitrate (LiNO₃), lithium perchlorate (LiClO₄), Lithium difluoro(oxalato)borate (LiDFOB) and Lithium bis(oxalato)borate (LiBOB).

18. The energy storage device of claim 17, wherein the amounts of said one or more lithium-containing salts comprise a majority of either LiPF₆ or LiBF₄ or a combination of the two.

19. The energy storage device of claim 18, wherein the combined molarity of LiPF₆ or LiBF₄ or a combination of the two ranges from about 0.8-2M.

20. The energy storage device of claim 19, further comprising other salts making up <0.5M.
